(19) United States
(12) Patent Application Publication
(10) Pub. No.: US 2010/0089471 A1
(43) Pub. Date: Apr. 15, 2010

(54) VALVE

(75) Inventors: Avraham ZAKAY, Zichron Yaakov (IL); Jonathan BAR-OR, Jordan Valley (IL); Amir DAVIDESKO, Givat Ada (IL)

Correspondence Address: THE NATH LAW GROUP, 112 South West Street, Alexandria, VA, 22314, US

(73) Assignee: A.R.I. FLOW CONTROL ACCESSORIES LTD., D.N. Ramat Hagolan (IL)

(21) Appl. No.: 12/553,580

(22) Filed: Sep. 3, 2009

Related U.S. Application Data
(63) Continuation-in-part of application No. 10/527,198, filed on Mar. 10, 2005, now Pat. No. 7,640,944.

(30) Foreign Application Priority Data
Sep. 12, 2002 (IL) 151748

(51) Int. Cl. F16K 15/00

(52) U.S. Cl. 137/528

(57) ABSTRACT

A valve comprising a housing and a pressure responsive sealing assembly. The housing comprises an inlet port, an outlet port and a control chamber extending therebetween. The control chamber having a first cross-sectional area at the inlet port, and a second cross-sectional area greater in magnitude than the first cross-sectional area and being disposed between the inlet port and the outlet port. The pressure responsive sealing assembly is normally biased into a first position in which the sealing assembly seals the inlet port. When a pressure differential about the inlet and outlet ports exceeds a predetermined threshold, the pressure responsive sealing assembly is configured to shift from the first position to a second position, in which the sealing assembly no longer seals the inlet port and a fluid flow path from the inlet port into the control chamber is opened. The fluid flow path is substantially obstructed in the second position at the second cross-sectional area of the chamber due to engagement thereat by the sealing assembly with the housing. The pressure responsive sealing assembly is configured to shift from the second position to a third position, in which the pressure responsive sealing assembly is disengaged from the housing at the second cross-sectional area allowing fluid to flow from the inlet port to the outlet port. The valve is formed with a bleed aperture configured to admit fluid flow therethrough in a direction from the inlet port to the outlet port.

This is a Continuation-In-Part of U.S. application Ser. No. 10/527,198 filed Sep. 4, 2003, the contents of which are hereby incorporated by reference in their entirety.

### FIELD

This subject matter herein relates to a valve. More particularly the subject matter herein is concerned with a valve that can increase accuracy of measurement of fluid at low flow rates.

### BACKGROUND

The measurement and monitoring of low volume fluid flows has various applications including applications in industrial and residential settings. For example, in the chemical industry the accurate and precise knowledge of inlet and outlet flows for a myriad of processes (e.g. chemical reactions) can be critical to the optimal production and processing of chemicals, pharmaceuticals and the like. Precise monitoring of flows can also be used to discover and prevent leaks which can be costly and be a safety issue.

Additionally, the lack of low-flow monitoring can result in losses to the suppliers of such flow. For example, water companies are compensated for water usage as measured by their flow monitors (water meters). If their flow monitors do not measure trickle or drip flow, they are not reimbursed for such usage. The loss of revenue can be considerable. Additionally, the location of the loss is not detected thereby allowing a large amount of water to be wasted. This is particularly an issue in the many countries with limited water supplies. Furthermore the knowledge of this monitoring limitation can be used to steal water, for example by slowly dripping water into a holding tank, at a rate not measurable by the associated flow meter, and consuming the water directly from the tank.

Turbine flow meters, which are the conventional magnetic flow meters in general use today have long been used to measure fluid flow by means of a turbine immersed in the fluid. A magnet connected to the turbine turns a second magnet, which is placed in a dry area. The second magnet drives a cog system that turns a mechanical counter. These flow meters are unable to detect low flows e.g. below about 10 l/h when considering a typical water meter of the type installed by water supply companies and municipalities world wide. Positive displacement metering devices are also commonly used to measure flow rate and they have deficiencies in particular where water is of poor quality i.e. has a high calcium content or contains dirt such as sand.

Other types of flow meters are also known, some of which are devices for measuring low volumetric fluid flow. However such meters are typically costly, require servicing and are difficult to retrofit, thus are usually not used for domestic water metering.

Droplet counter devices are also known, wherein a sensor is provided for droplet count. However, such devices usually serve for laboratories and are not cost-effective in massive installation, e.g. for use by a water supply company, certainly not for urban use. Even more so, such systems are not easily retrofitted and they require some considerable space.

For example, disclosed in U.S. Pat. No. 5,218,346 to Meixler is a low volume flow meter for determining if a fluid flow meets a minimum threshold level of flow. The monitor includes an externally located electrical portion, which operates with a minimum of intrusion to the flow and allows for repairs. The electronics provide for the adjustment of the threshold level and can be modified to provide for a parallel electronic circuit for a bracketing of the desired flow rate. However, the system is not simple or inexpensive.

Another type of flow rate device that has the capacity to measure or monitor a low flow rate is a compound meter. In this case, the device comprises a high flow metering device together with a secondary flow meter that is typically located in a by-pass conduit. There is typically some means for diverting flow (e.g. by using a “change-over” valve set to activate at a pre-determined pressure) based on a pre-determined flow rate or pressure in order to direct the flow to the appropriate meter. These meters typically suffer from at least some of the above-mentioned drawbacks and in particular are expensive.

A problem which can occur with flow metering devices is so-called ‘over-efficiency’, where the flow meter can read excessive amounts of fluid, which in fact have not flown through the system. This can result for example, owing to inertial revolutions of the measuring impeller of the metering device.

### SUMMARY

According to the subject matter herein, there is provided a fluid supply system comprising a supply line and flow metering device and a flow responsive valve; the flow responsive valve admitting flow through the system for only measurable fluid flow.

The valve can be configured to admit fluid flow therethrough at only at a measureable flow rate, by only opening from a closed state upon a sufficient pressure differential about its inlet and outlet ports.

The subject matter herein provides a valve comprising a housing and a pressure responsive sealing assembly; the housing comprises an inlet port, an outlet port and a control chamber extending therebetween; the control chamber having a first cross-sectional area at the inlet port, and a second cross-sectional area greater in magnitude than the first cross-sectional area and being disposed between the inlet port and the outlet port; the pressure responsive sealing assembly being normally biased into a first position in which the sealing assembly seals the inlet port; when a pressure differential about the inlet and outlet ports exceeds a predetermined threshold, the pressure responsive sealing assembly being configured to shift from the first position to a second position, in which the sealing assembly no longer seals the inlet port and a fluid flow path from the inlet port into the control chamber is opened, the fluid flow path being substantially obstructed in the second position at the second cross-sectional area of the chamber due to engagement thereat by the sealing assembly with the housing; the pressure responsive sealing assembly being configured to shift from the second position to a third position, in which the pressure responsive sealing assembly is disengaged from the housing at the second cross-sectional area allowing fluid to flow from the inlet port to the outlet port; the valve being formed with a bleed aperture configured to admit fluid flow therethrough in a direction from the inlet port to the outlet port.

For the purposes of the specification and the claims: A “cross-sectional area” of a valve refers to an area of a cross-section taken along a plane perpendicular to the longitudinal axis of the valve, at a predetermined point therealong.

The second cross-sectional area can be at least two times the magnitude of the first cross-sectional area. The second cross-sectional area can be at least four times the magnitude of the first cross-sectional area.

It will be understood that increasing the ratio of magnitude of the second cross-sectional area, in comparison with the first, will increase a flow rate through the valve when it is caused to be opened by a pressure differential caused by a leak.

The bleed aperture can be configured to assist the pressure responsive sealing assembly to move from the second position to the first position, upon fluid flow through the bleed aperture below a predetermined leak rate threshold.

It will be appreciated that for different systems, different predetermined thresholds can be appropriate. For certain specific large systems, such as commercial or apartment block systems, the predetermined threshold can be less than 400 liters per hour. It will be clear that for other systems, for example single home systems, the predetermined threshold can be a value far less than 400 liters per hour, for example, the predetermined threshold can be less than 100, 50, 25, or 5 liters per hour.

The control chamber can have a third cross-sectional area greater in magnitude than the magnitude of the first and second cross-sectional areas combined, the third cross-sectional area being disposed between the second cross-sectional area and the outlet port.

The sealing assembly can comprise an axially displaceable sealing member having an inlet sealing surface and an annular shoulder portion spaced from the inlet sealing surface.

The inlet sealing surface can be configured to seal the inlet port, when the pressure responsive sealing assembly is in the first position.

The annular shoulder portion can be configured to extend to and engage the housing at the second cross-sectional area of the control chamber, when the pressure responsive sealing assembly is in the second position. The annular shoulder portion can be formed with the bleed aperture. The housing can be formed with the bleed aperture. The annular shoulder portion can be configured for cleaning the housing. The annular shoulder portion can be integrally formed with the sealing member. Alternatively, the annular shoulder portion can be non-integral with the sealing member.

The pressure responsive sealing assembly can comprise a sealing member and a stopping assembly configured to arrest motion thereof.

The stopping assembly can comprise a piston configured to be axially displaceable.

The pressure responsive sealing assembly can comprise a sealing member and a stopping assembly configured to arrest motion thereof.

The sealing member and stopping assembly can both being formed with convexly curved complimentary mating shapes configured to form an egg-like shape when brought together.

The housing can comprise a diaphragm seal mounted on the inlet port and comprising an inner end configured for sealing engagement with the pressure responsive sealing assembly in the first position.

The housing can comprise an inner cylinder to provide different cross-sectional areas therein. Alternatively the housing can be a single integral unit with different cross-sectional areas.

The first cross-sectional area can be an area within the inner end of the diaphragm seal.

The diaphragm seal can comprise outer and inner ends.

The outer end can be configured for mounting the diaphragm seal to the inlet port.

The inner end can be configured to project inwardly and can be formed with a sharp-edged corner. The sharp-edged corner can be formed with a substantially right-angled shape. The inner end can be formed with a curved corner.

The diaphragm seal can comprise an outer end, an inner end and a central portion extending therebetween.

The outer end can be configured for mounting the diaphragm seal to the inlet port.

The inner end can be a projection configured for sealing engagement with a sealing member of the sealing assembly.

The central portion can comprise an additional projection configured to extend in a direction away from the central portion thereby allowing engagement with a sealing member of the sealing assembly to cause the additional projection to bend in a direction away from the inner end of the diaphragm seal.

The diaphragm seal can be made of an elastic material.

The diaphragm seal can be made of a flexible material.

The diaphragm can be configured to flex and remain in contact with the sealing element when it begins to move, and to snap back to a normal position, upon sudden detachment from the sealing element, when the sealing element moves sufficiently far away from the diaphragm seal.

The pressure responsive sealing assembly can further comprise a biasing mechanism. The biasing mechanism can be configured to normally bias the sealing member into sealing engagement with the inlet port. The biasing mechanism can comprise a spring.

The valve can be a one way valve, preventing fluid flow through the inlet port in a direction away from the outlet port.

The valve can further comprise a delay assembly configured to engage the pressure responsive sealing assembly and slow movement thereof from the second or third position to the first position.

The delay assembly can comprise a sealing element configured to extend between the sealing member and another part of the valve, thereby creating a confined space between the sealing member and the part of the valve.

The sealing member can be configured to allow a first fluid flow rate for fluid exiting the confined space and a second fluid flow rate for fluid entering the confined space.

The first fluid flow rate can be greater than the second fluid flow rate. The part of the valve can be a part of a stopping assembly configured to arrest motion of the sealing member.

The sealing element can be a sleeve comprising first and second ends and a central portion extending therebetween.

The sealing element's first end can be securely mounted on the sealing member.

The sealing element's second end can be engaging the part of the stopping assembly.

The central portion can be configured to bend and can be elongated sufficiently to engage the part of the stopping assembly at a point thereof spaced from the sealing member.

The part of the stopping assembly engaged by the sealing element can be formed with a groove along an external surface thereof, configured to allow fluid flow into the confined space at the second fluid flow rate.

The groove can be diagonal with respect to a longitudinal axis of the valve.

The diagonal orientation of the configuration is configured to allow an increased circumferential length of the sealing element to engage with the groove as the piston displaces axially, thereby preventing partial closing of the groove by the sealing element due to local relaxation.

The valve can be formed with a bleed aperture configured to admit fluid flow therethrough in a direction from the inlet port to the outlet port.

The pressure responsive sealing assembly can further comprise a stopping assembly configured to arrest motion of the sealing member.

The stopping assembly can comprise a piston configured to be axially displaceable.

It will be appreciated that the delay assembly is a further inventive feature that can be used together with or separately from a valve having any of the features mentioned above.

The subject matter herein provides a valve comprising a housing, a pressure responsive sealing assembly and a delay assembly; the housing comprises an inlet port an outlet port and a control chamber extending therebetween; the pressure responsive sealing assembly comprising a displaceable sealing member configured to be displaced from a closed position, in which the sealing member seals the inlet port, to an open position in which the sealing member is disengaged from the inlet port to admit fluid flow through a fluid flow path between the inlet and outlet ports; the delay assembly being configured to engage the sealing member and slow movement thereof from the open position to the closed position.

A valve in accordance with the preceding paragraph can have any of the features mentioned above or below.

It will be appreciated that such valves as those in the subject matter herein, can be inserted into a pipe and also into any appropriate component. For example, such valve may be inserted into a faucet or other body having fluid flow therethrough.

A further arrangement is such that when a flow rate in the fluid supply system exceeds a minimal measurable flow rate threshold the flow responsive valve is open owing to a pressure differential over its inlet port and outlet port; and when the flow rate drops below the minimal measurable flow rate threshold, the valve enters a pulsating position having a closed state thereby substantially restricting flow through the system, and an open state allowing fluid flow into the system; said open state having a flow rate exceeding the minimal measurable flow rate threshold; where portions of the supply line downstream of the flow meter and devices fitted thereon function as a fluid accumulator.

According to the subject matter herein, an average fluid flow through the system remains constant over time, whereby a consumer downstream of the metering device does not acknowledge flow rate fluctuations imparted by the system according to the subject matter herein.

According to the subject matter herein, there is a fluid metering system comprising a fluid supply line and a meter for measuring fluid flow therethrough, the meter having a minimum measuring flow threshold; the system further comprising a flow responsive valve imparting the system with a flow pattern having a pulsating character so as to substantially prohibit flow at a flow rate below the minimum measuring threshold, and resume flow of only measurable quantities of fluid. The flow responsive valve is in fact responsive to flow rate and to pressure differential extending between an inlet and an outlet of the valve.

According to another aspect the subject matter herein is concerned with a method for metering fluid flow through a fluid supply line comprising a flow meter having a minimum measurable threshold and a flow responsive valve imparting a flow pattern therethrough with a pulsating character so as to substantially restrict flow at a flow rate below the minimum measuring threshold, and resume flow of only measurable quantities of fluid. The arrangement is such that the fluid supply line and any devices fitted thereon function as an accumulator, whereby at an open state of the flow responsive valve, during its open phase, fluid accumulates in the system.

The subject matter herein is also directed to a valve comprising an inlet port connectable to an upstream side of a fluid supply line, and an outlet port connectable to a downstream side of the fluid supply line; a control chamber extending between the inlet port and the outlet port and a sealing member disposed within the control chamber; the sealing member having an inlet sealing surface having a sealing surface area and a control portion having a control surface area; and a bleed aperture determining a minimal flow threshold through the control chamber; wherein the sealing member displaces between an open position and a closed position depending on a pressure differential over the sealing member.

A fluid supply system according to the concerned subject matter herein is suitable for use with gases or fluids and can have a significant advantage of being inexpensive, reliable and suitable for easy retrofit installation on existing flow metering systems.

A further advantage of the device in accordance with the present subject matter herein can be that it serves also as a one way valve preventing flow from a downstream direction to an upstream direction, i.e. from the consumer towards the supplier, in the case of a fluid supply system.

According to another embodiment of the present subject matter herein there is provided a flow responsive valve according to the subject matter herein further fitted for controlled restriction of fluid flow at the open state of the pulsating position of the device.

Accordingly, an impeller of a flow meter fitted in conjunction with a valve according to the subject matter may not reach significant revolutionary speed and inertial force is reduced, thereby governing the overriding excessive metering.

However, the valve according to this embodiment substantially may not affect fluid flow and metering at a consuming state thereof, i.e. when flow rate exceeds a minimal measurable flow rate threshold.

### BRIEF DESCRIPTION OF THE DRAWINGS

In order to understand the subject matter herein and to see how it can be carried out in practice, some embodiments will now be described, by way of non-limiting examples only, with reference to the accompanying drawings, in which:

FIG. 1 is a schematic representation of a municipal water supply network fitted with a flow metering system;

FIG. 2 is a superimposed graph schematically illustrating the pressure and flow rate over time, in a water supply network fitted with a flow metering system;

FIG. 3A is a longitudinal section through a flow responsive valve according to an embodiment of the subject matter herein illustrating the valve in its open position;

FIG. 3B is a longitudinal section through a flow responsive valve according to an embodiment of the subject matter herein illustrating the valve in its closed position;

FIG. 4A is a longitudinal section through a flow responsive valve according to another embodiment of the subject matter herein illustrating the valve in its open position;

FIG. 4B is a longitudinal section through a flow responsive valve according to another embodiment of the subject matter herein illustrating the valve in its closed position;

FIG. 5A is a longitudinal section through a flow responsive valve according to still an embodiment of the subject matter herein, illustrating the valve in its open position;

FIG. 5B is a longitudinal section through a flow responsive valve according to still an embodiment of the subject matter herein, illustrating the valve in its closed position;

FIG. 6 is a schematic graph representing actual flow versus measured flow, at several conditions;

FIG. 7 is a longitudinal section through a flow responsive valve according to an embodiment of the subject matter herein, fitted for controlled fluid flow restriction;

FIGS. 8A to 8F are longitudinal sections through the valve of FIG. 7, at consecutive operative positions;

FIG. 9A is a side perspective view of a flow responsive valve according to another embodiment of the subject matter herein;

FIG. 9B is a side view of the flow responsive valve of FIG. 9A;

FIG. 9C is a top view of the flow responsive valve of FIGS. 9A and 9B;

FIG. 9D is a bottom view of the flow responsive valve of FIGS. 9A-9C;

FIG. 9E is a schematic section along line A-A in FIG. 9D, of the flow responsive valve in FIGS. 9A-9D, in a closed position;

FIG. 9F is a schematic section along line A-A in FIG. 9D, of the flow responsive valve in FIGS. 9A-9E, in a position where a pressure responsive sealing assembly of the valve has moved slightly from its position in the closed position in FIG. 9E;

FIG. 9G is a schematic section along line A-A in FIG. 9D, of the flow responsive valve in FIGS. 9A-9F, in a position where the pressure responsive sealing assembly of the valve has moved even further away from its position in the closed position in FIG. 9E, than the position shown in FIG. 9F;

FIG. 9H is a schematic side perspective view of the flow responsive valve in FIGS. 9A-9F, in the position also shown in FIG. 9G;

FIG. 9I is a schematic section along line A-A in FIG. 9D, of the flow responsive valve in FIGS. 9A-9H, in a fully open position;

FIG. 9J is a schematic section along line A-A in FIG. 9D, of the flow responsive valve in FIGS. 9A-9I, in a backflow position;

FIG. 9K is a schematic section along line A-A in FIG. 9D, of the flow responsive valve in FIGS. 9A-9J, in another backflow position;

FIG. 9L is a schematic section of a flow responsive valve according to another embodiment of the subject matter herein, which is similar to that shown in FIGS. 9A-9K, with the exception of the diaphragm seal; and

FIG. 9M is a schematic side view of the piston of the flow responsive valves in FIGS. 9A-9L.

### DETAILED DESCRIPTION

The subject matter herein is suitable for implementation in a variety of fluid supply systems; however, for the sake of convenience and for exemplifying only, reference hereinafter is made to a water supply system, e.g. an urban/municipal water supply network.

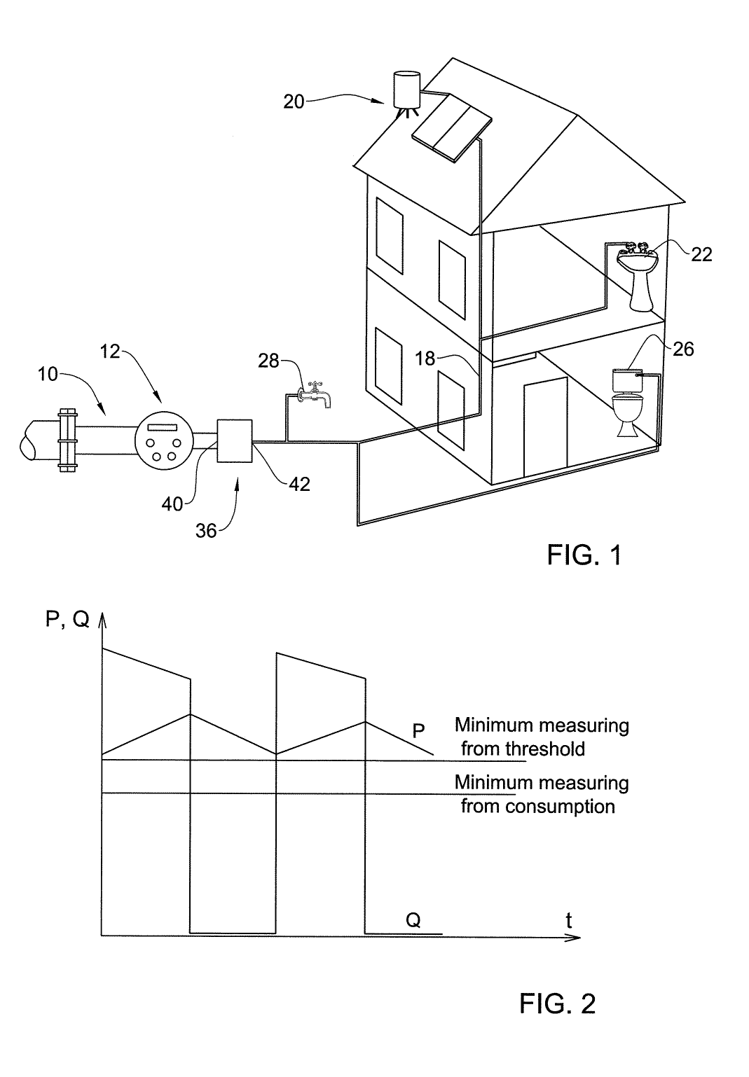

Attention is first directed to FIG. 1 of the drawings schematically illustrating an end portion of an urban/municipal water supply system wherein an end user is for example a house, an office, a plant, etc. The house, in the present example, is connected to a main water supply line designated 10 via a flow meter 12 with a suitable network of pipes 18 branching, for example to end devices such as a solar water heating system 20, wash basins 22, toilets 26 and garden faucets 28.

Each of the above end items, including the piping 18 is vulnerable to leaks owing to faulty sealing means (washers, gaskets, etc.), leaks in the piping, poor connections, etc.

In a water supply system not fitted with a device in accordance with the subject matter herein, any such leaks which are below the minimal measurable flow rate threshold (a common such minimal threshold is about 10 liter/hour) would not be detected and would not be measurable, i.e. causing the water supplier considerable loss, not to mention the waste of fresh water which in some regions in the world is an acute problem.

In order to render a standard flow meter 12 capable of measuring also small amounts of water, there is installed a flow responsive valve generally designated 36. The valve 36 is sensitive to flow rate and pressure differential over its inlet and outlet ports, as will be explained hereinafter in more detail

The valve 36 is a normally closed valve which opens whenever an end device is opened for consumption of water, e.g. upon flushing the toilet 26 or the like, when the consumed rate exceeds the minimal measurable flow rate threshold. However, when there is no consumption of water by any of the end devices, the valve 36 spontaneously returns to its closed position.

If a leak occurs at one or more locations along the piping 18 or at one or more of the end devices 20, 22, 26 and 28, the flow responsive valve 36 remains closed whereby a pressure differential ΔP is being built between an inlet port 40 connected upstream and an outlet port 42 connected downstream. Such pressure differential ΔP is built owing to the essentially constant pressure at the inlet port 40 and the dropping pressure at outlet port 42. When the pressure differential ΔP reaches a predetermined threshold, the flow responsive valve 36 opens for a while, to allow water flow to the piping 18 until the valve reaches a pressure differential lower then a predetermined pressure threshold.

FIG. 2 is a superimposed graph schematically illustrating the pressure and flow rate over time, measured downstream of the flow responsive valve 36. The upper horizontal line represents the minimal measurable flow threshold of the metering device 12 whilst the lower horizontal line represents the flow consumption during a low flow consumption, e.g. owing to several leaks at the piping 18 and/or end devices 20, 24, 26, and 28 which are below the minimum measurable flow threshold of the metering device 12. The graph represented by the letter Q represents the pulsating flow character through the flow meter where it is noticeable that flow is always above the minimum measurable flow threshold of the metering device 12 and operates in an on/off mode, i.e. all flow through the meter 12 is measurable. The line represented by the letter P illustrates the corresponding pressure in the system which also has a pulsating character.

Further attention will now be directed to several embodiments of a pressure sensitive valve in accordance with embodiments of the present subject matter herein by way of examples only. It is appreciated that many other embodiments are possible as well.

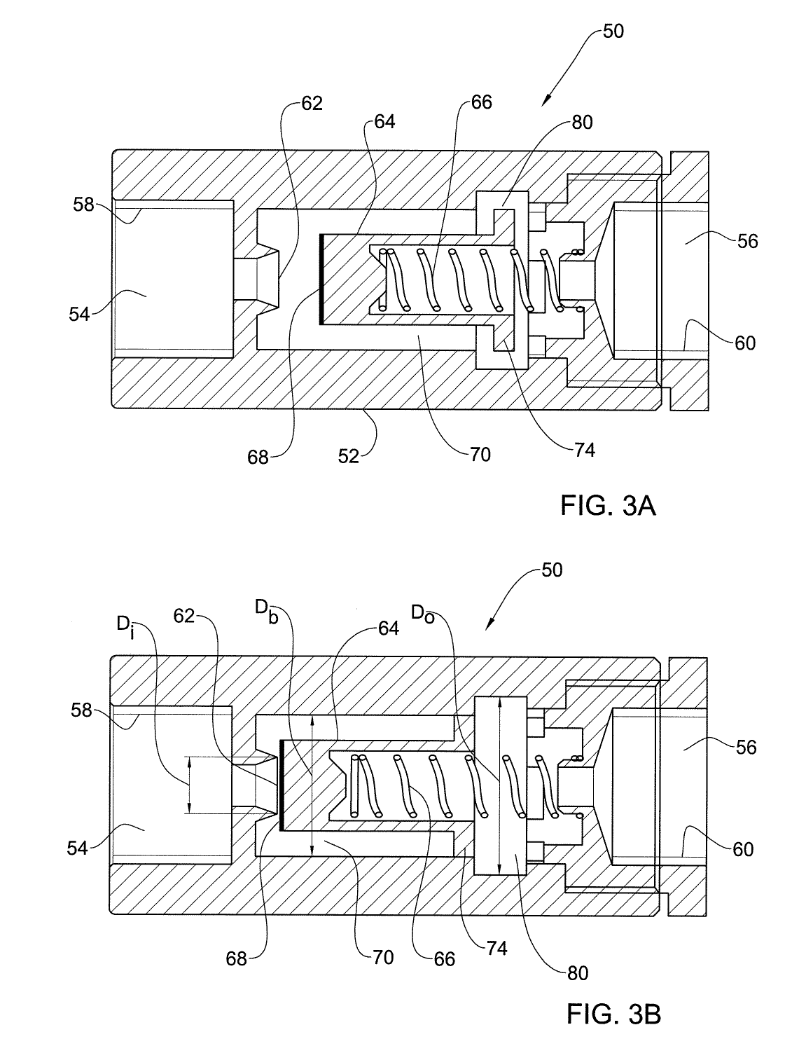

Turning now to FIGS. 3A and 3B, reference is made to a valve generally designated 50 which in FIG. 3A is illustrated in its open position and in FIG. 3B is illustrated in its normally closed position. The valve 50 comprises a housing 52, an inlet port 54 and an outlet port 56 both fitted for screw coupling to a pipe section (not shown) by suitable threadings 58 and 60, respectively.

The valve 50 is fitted with an inlet nozzle 62 having a diameter Dᵢ. A sealing member 64 is axially displaceable within the housing 52 and is normally biased by means of coiled spring 66 into a normally sealed position, so as to seal the inlet nozzle 62 (FIG. 3B).

Sealing member 64 is fitted at an inlet end thereof with a resilient sealing portion 68 for improved sealing of the inlet nozzle 62. Furthermore, and as noted in the figures, the housing 52 has a central bore 70 slidingly supporting the sealing member 64, the bore 70 having a diameter D_{b}. Sealing member 64 has at an outlet end thereof adjacent a shoulder portion 74 having a predetermined tolerance with the bore 70, the tolerance determining a leak rate corresponding with the pulsating sequence imparted to the sequence, as discussed above.

Further noticeable, bore 70 is formed at an outlet side thereof with an expanded portion 80 of diameter Dₒ.

The arrangement is such that when the valve 50 is in its open position, the shoulder portion 74 of the sealing member 64 reaches the expanded portion 80 to allow essentially free flow through the valve 50.

The arrangement is such that the biasing force Fs of the spring 66 is predetermined whereby the valve 50 remains in its closed position as long as the pressure differential ΔP does not exceed a predetermined pressure determined by the relationship between D_{I}, Fs and the pressure at the inlet port 54 and outlet port 56. Thus, the force required to open the valve 50 is determined by Fs<ΔP*A(Dᵢ), where A(Dᵢ) is the surface area at the inlet nozzle 62. Similarly, the valve 50 will close when ΔP<Fs/A(Dₒ), where A(Dₒ) is the surface area at the expanded portion 80. It is also apparent that the pressure differential required for closing the valve 50 is lower than that required for generating a pulse in the system, this being since Dᵢ<Dₒ.

The arrangement is such that when the pressure differential over the inlet port 54 and outlet port 56 is smaller than a predetermined threshold, the valve 50 remains sealed since the only force acting is the biasing force Fs of spring 66. However, when pressure at the outlet port 56 drops (e.g. upon a leak at the piping of the system or at one of the end devices, as discussed hereinabove) and there the inlet pressure at inlet port 54 remains essentially constant, the pressure differential over the valve 50 increases and the sealing member 64 will displace into its open position as in FIG. 3A.

Furthermore, it is appreciated that the shoulders 74 of the sealing member 64 take the role in retaining the sealing member in the open position under a pressure differential. It is further appreciated that the tolerance between the diameter of the shoulder 74 and the bore 70 in fact determines the pulsating timing, as it determines a so-called leak rate of the system.

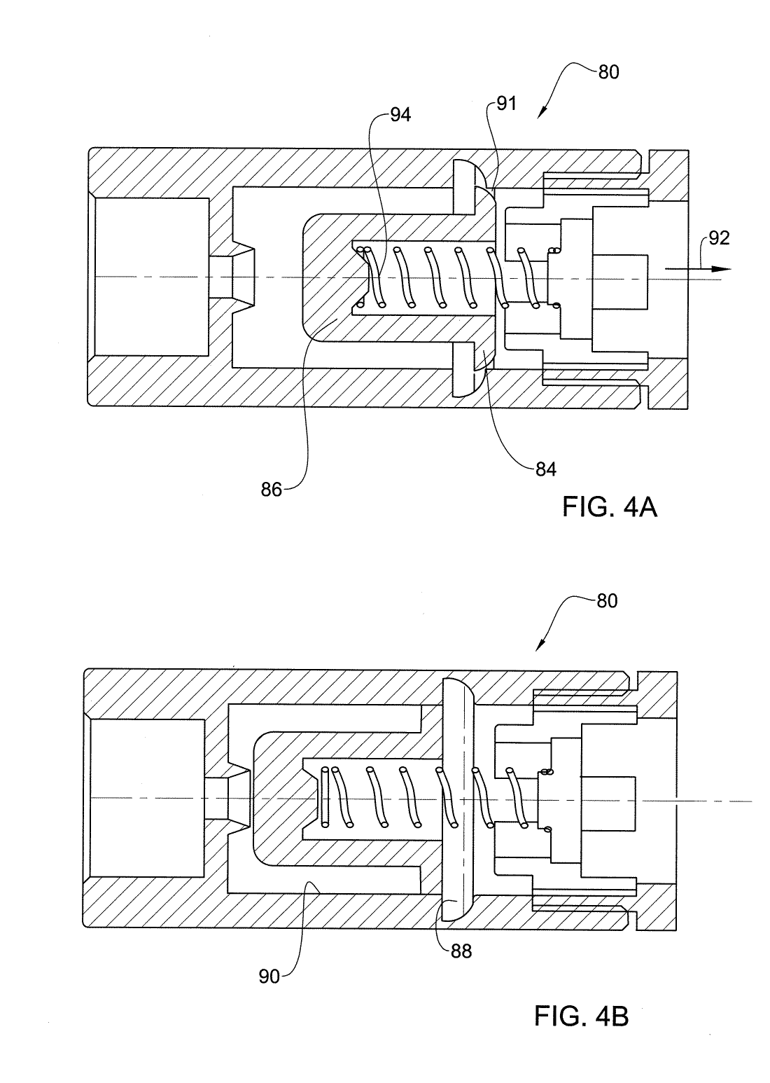

Further attention is now directed to FIGS. 4A and 4B in which a valve is principally similar to the valve discussed hereinabove in connection with FIGS. 3A and 3B and accordingly, reference is made only to the differing element which is the shape of the shoulder 84 of the sealing member 86 and the corresponding change in shape of the expanded portion 88 of the cylindrical bore 90 of the housing. The purpose of this particular design is to give rise to a narrow flow path 91 when the valve is in its open position as in FIG. 4, to thereby give rise to an increased flow velocity and at the bore 90, generating a force acting in the direction of arrow 92 (FIG. 4A) namely in the direction to assist in displacing the sealing member 86 into an open position, contrary to the force imparted by coiled spring 94. This is obtained by local increase of flow velocity causing low static pressure down stream, thus decreasing the head loss.

The design of FIGS. 4A and 4B renders the valve open/closed position more significant and avoids undefined positions and scattering of the valve at near to equilibrium position.

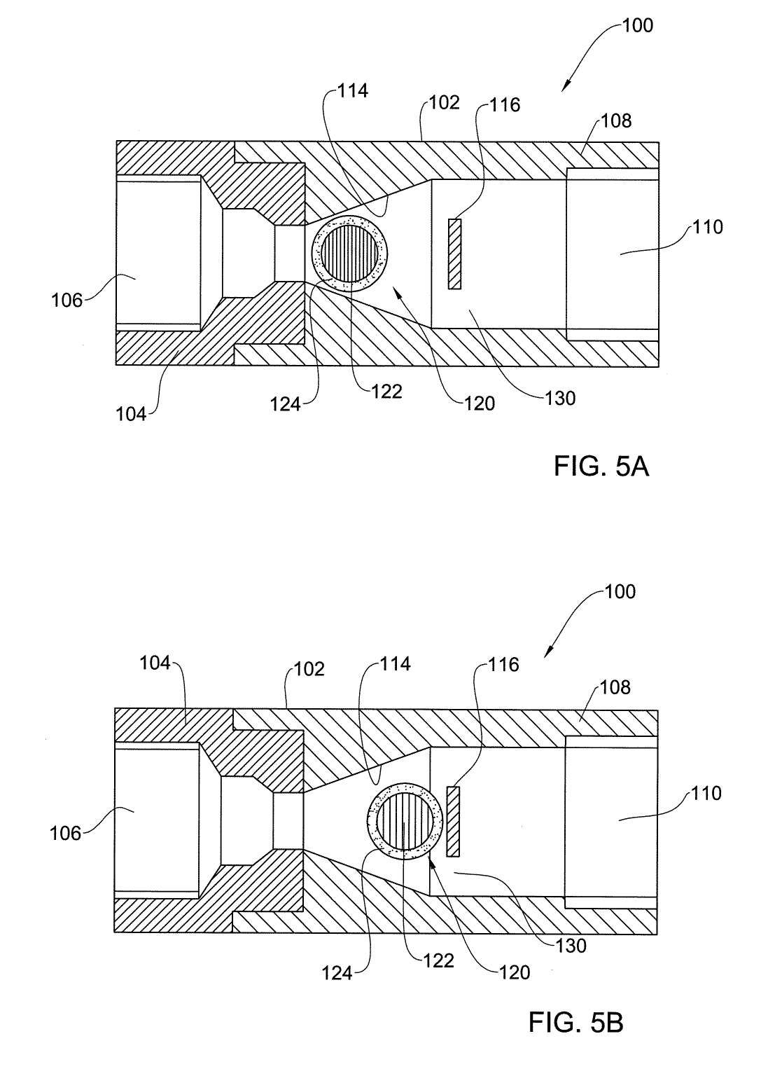

FIGS. 5A and 5B illustrate still another embodiment of a pressure sensitive valve in accordance with the subject matter herein generally designated 100 wherein the sealing force is imparted by magnetic means, rather than by a coiled spring as in the previous embodiment.

As can be seen in FIGS. 5A and 5B, the housing comprises an inlet segment 104 formed with an inlet port 106, and an outlet segment 108 fitted with an outlet port 110, both the inlet and the outlet being fitted with a suitable threading for coupling to a pipe segment (not shown).

Outlet segment 108 is formed adjacent the inlet segment 104 with a tapering portion 114 and with a stopper member 116. A sealing member 120 being a magnetic sphere 122 coated with a resilient layer 124, has a diameter larger than the narrow most portion of the tapering wall 114 and similarly, the diameter of the sealing member 120 is larger than the gaps 130 of stopper member 116. The arrangement is such that the sealing member 120 is displaceable within the housing between a closed position (FIG. 5A) wherein it sealingly engages the tapering wall portion 114, and an open position (FIG. 5B), wherein it disengages from the tapering portion 114 to allow free flow through the valve 100.

The biasing force is imparted on the sealing member 120 by means of the magnetic inlet member 104 acting on the magnetic sphere 122 of sealing member 120 into sealing engagement with the narrow most portion of the tapering wall portion 114.

The valve in accordance with the embodiment of FIGS. 5A and 5B operates in a similar manner as discussed in connection with the valves of FIGS. 3 and 4 and the reader's attention is directed thereto.

A further advantage of the valve in accordance with the subject matter herein , is that it may serve also as a one way valve preventing flow from a downstream direction (i.e. from the consumer) to an upstream direction (i.e. towards the supplier). This feature may be of particular importance e.g. in connection with a water supply system and serves to prevent flow of contaminated water towards the supplier in case of a flood or burst in supply pipes, where there is risk of mud and dirt entering the system and flowing upstream and possibly contaminating water reservoirs and harming equipment of the water supplier.

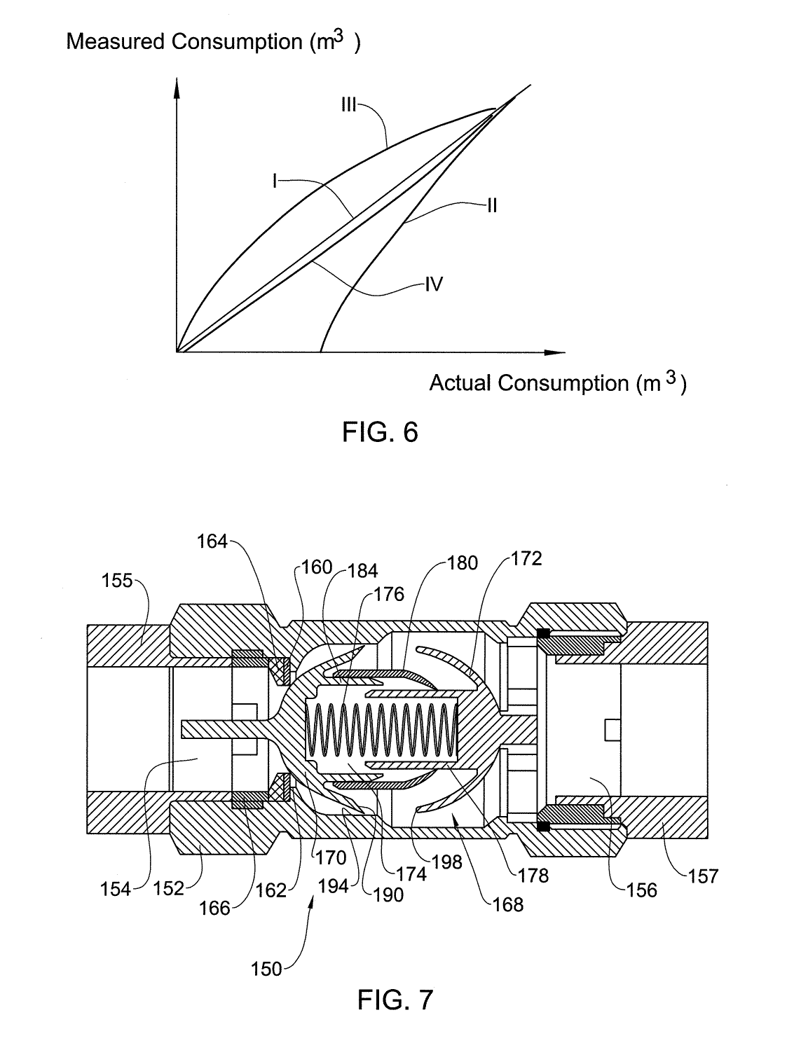

Turning now to FIG. 6, there is illustrated a schematic graph representing various situations of measured flow consumption MC versus actual flow consumption AC, in volumetric units, e.g. m3. The line marked I represents the ideal situation where actual water consumption is essentially identical to measured water consumption in a linear fashion. However, this situation will usually not occur owing to the design of common flow meters, e.g. domestic water meters etc., whereby an impeller is provided, the latter gaining inertial forces subject to velocity of water flowing therethrough. Accordingly, even after termination of fluid flow through the flow meter, the impeller will tend to continue revolving for a while, owing to the inertial forces. It is appreciated that this situation is not desired in particular where monitoring of fluid flow is of importance or where it is desired to correctly charge for actual water consumption.

The measured consumption MC for a typical flow meter not fitted with a device in accordance with the subject matter herein is represented by line II and it is thus appreciated that there is a significant portion of unmeasured fluid which cannot be measured and respectively charged.

Upon installation of a valve in accordance with some embodiments, the flow meter may yield an ‘over efficient’ performance illustrated in FIG. 6 by the line marked III, i.e. measuring quantities of water which in fact were not consumed. This phenomena takes place owing to many occurrences of closing and opening the valve, involving inertia forces.

Accordingly, it is desirable to introduce a device which may compensate for the ‘over efficiency’ and will reach a measured consumption near to actual consumption as illustrated for example by line marked IV.

It is appreciated that, for the sake of good order, the performance of the valve in accordance with the line marked IV extends below the optimal line marked I, so as to ensure that the consumer remains under charged rather than over charged.

With further attention now directed to FIG. 7, there is illustrated a modification of the valve in accordance with the subject matter herein, generally designated 150 comprising a housing 152, an inlet port 154 screw coupled to an upstream pipe section 155, and an outlet port 156 screw coupled to a downstream type pipe section 157.

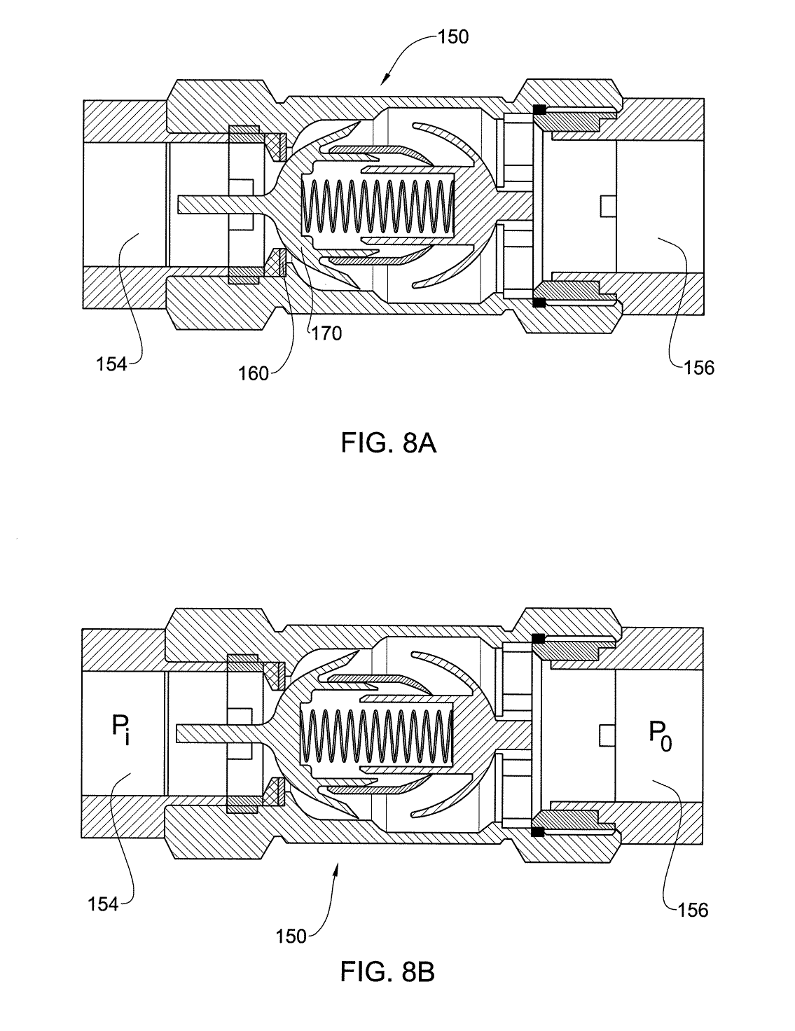

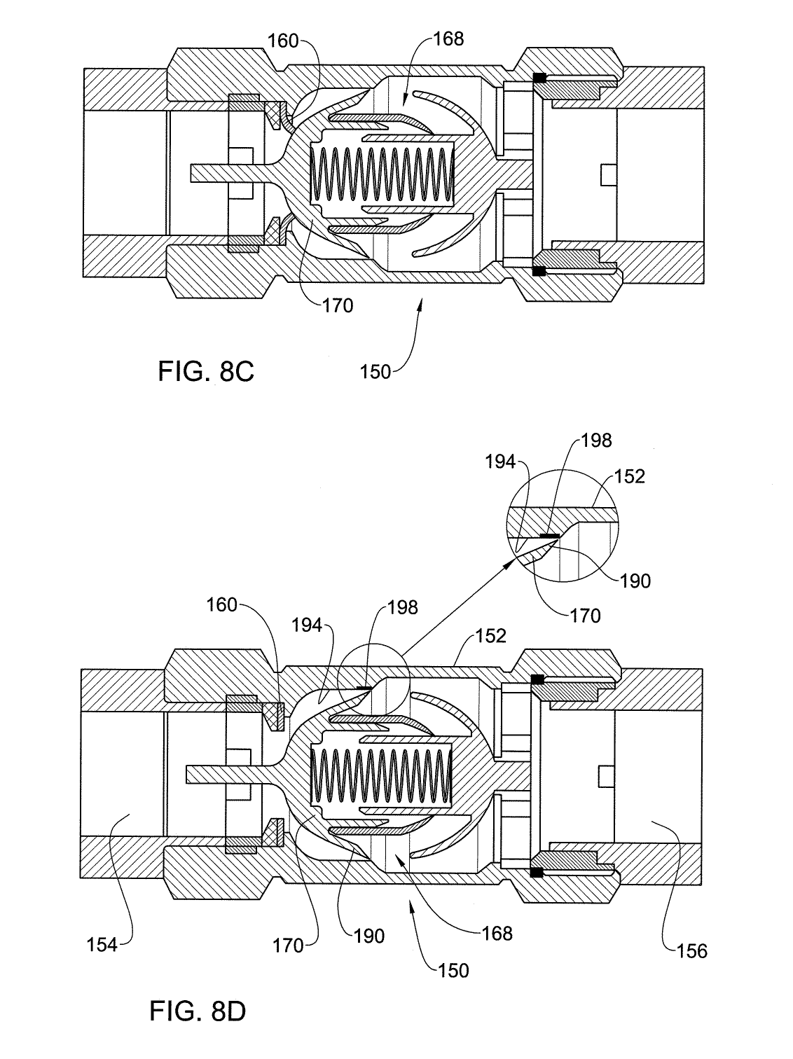

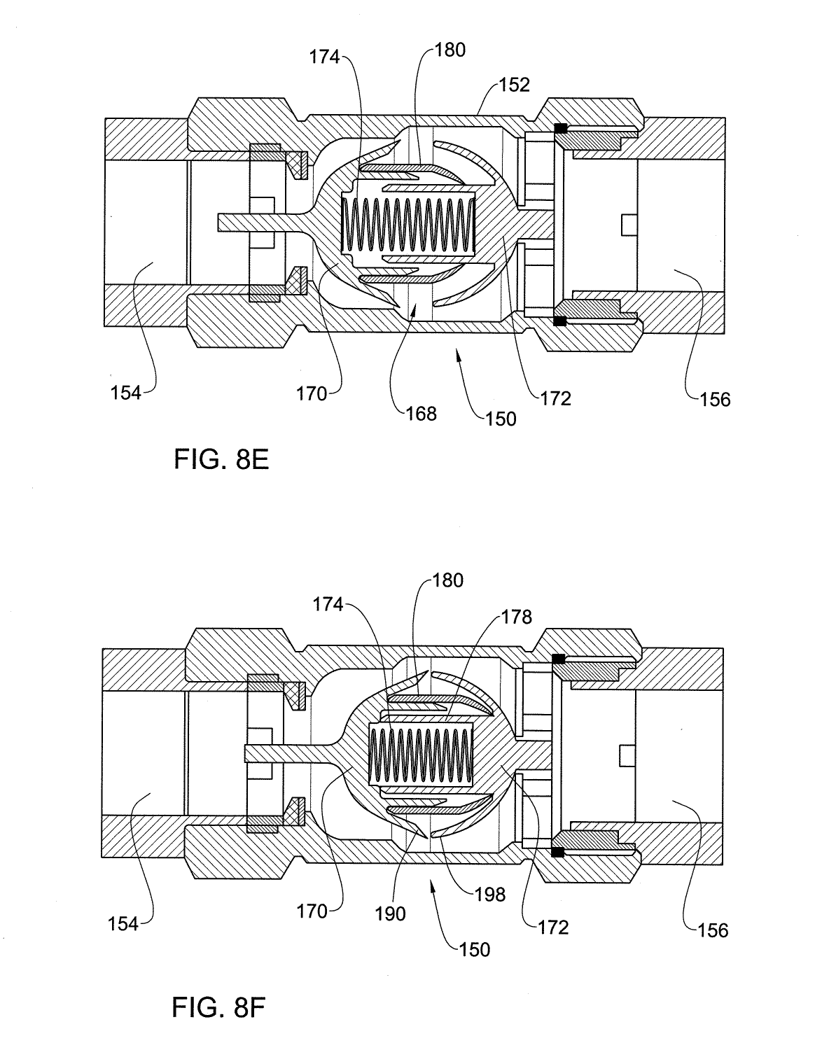

Fitted at the inlet and of the housing there is provided a diaphragm seal 160 retained between an annular shoulder portion 162 of the housing and a diaphragm support disk 164 retained by a retention nut 166, whereby the diaphragm seal 160 is deformable only in a downstream direction, as will be apparent hereinafter, in connection with FIG. 8C.

Diaphragm seal 160 tends to follow displacement of a plunger 170 owing to pressure differential about its faces. However, at a certain stage the diaphragm seal disengages from the plunger and will return to its normal position at rest.

A pressure responsive sealing assembly is received within the housing 152, comprising an axially displaceable plunger 170 and a stationary cup member 172.

Formed between the plunger 170 and the cup member 172 there is a damping assembly received within a confined space 174, which in the present example holds a coiled spring 176 received within the cylindrical sleeve 178 of the cup member 172, said spring biasing at one end against the cup member 172 and at an opposed end thereof against the plunger 170. A sealing sleeve 180, made of a resilient material, is applied over the cylindrical extension 184 of the plunger 170 and 178 of the cup member 172, to thereby restrict fluid flow into the confined space 174.

The circumferential peripheral edge 190 of the plunger 170 is sharp-edged serving as a scraper bearing against the cylindrical surface 194 of the housing, continuously cleaning it from scale, algae and other dirt particles, as the plunger 170 axially displaces within the housing.

According to a particular embodiment, as illustrated in FIG. 7, the plunger 170 and the cup member 172 have complementary shapes offering an advantage in particular in the completely open position of FIG. 8F, upon water consumption downstream. Furthermore, it is noted that the circumferential peripheral edge 198 of the cup member 172 is chamfered so as to easily engage with the corresponding scraper edge 190 of the plunger 170.

Further attention is now directed to FIGS. 8A to 8F, illustrating how the valve in accordance with the embodiment of FIG. 7 actually operates. In FIG. 8A, plunger 170 is in its retracted position, remote from the cup member 172 and sealingly bearing against the diaphragm seal 160. This position is the so-called closed position wherein there is no water consumption and no water leak. In this situation, water pressure at the inlet port 154 is substantially equal to the pressure at the outlet port 156, i.e., the pressure differential ΔP equals 0 namely, the inlet pressure equals the outlet pressure (Pi=Po).

However, at the position illustrated in FIG. 8B, the valve 150 is still at the so-called closed position with no significant water consumption downstream of the valve, however, with some water leak occurring, at a flow rate which is below the measurable threshold of the water metering device (not shown). This results in pressure decrease at the outlet side of the valve 150, building up a pressure differential ΔP≧0 over the valve, where Pi is greater than Po. However, the pressure differential is still not significant and will not displace the valve into the open position. For the sake of clarity, high pressure zone is indicated in FIGS. 8A-8F by dense dotting whereas low pressure zone at the valve is indicated by non-densed dotting. It is apparent that in the situation of FIG. 8B the valve remains in the closed and sealed position wherein the diaphragm seal 170 sealingly bears against the diaphragm seal 160.

Resulting in further leakage, downstream of the valve 150 (however with no significant consumption) the pressure differential over the device 150 increases, causing the plunger 170 to slightly extract in a downstream direction, as seen in FIG. 8C, however followed by deformation of the diaphragm seal 160 which follows the plunger 170 and ensures that the valve is closed. It is apparent that as long as no water flow occurs between the inlet port towards the outlet port, the water metering device (not shown) does not sense any flow and will not indicate flow as the measuring element (e.g. an impeller) remains still.

Referring now to FIG. 8D, as the pressure continues to drop at the outlet port 156, water leaks through an interstice between the plunger 170 and the surface 194 of the housing 152, resulting in slight pressure increase at the outlet port 156, and further resulting in displacement of the diaphragm seal 160 to its normal position.

In order to facilitate leakage between the scraper edge 190 of the plunger 170 and the surface 194, one or more narrow grooves 198 are formed at contact zone of the scraper edge 190 with the surface 194, as illustrated in the enlarged portion of FIG. 8D.

Disengagement of the diaphragm seal 160 from the plunger 170 (FIG. 8D) results in further displacement of the plunger 170 towards the cup member 172, whereby water flow is increased, further resulting in pressure equilibrium about the sealing assembly 168. Such an increase in water flow is above the minimal readable threshold of the metering device (not shown) and thus the water now flowing through the device at such a pulsating opening of the valve, is measurable by the flow meter.

The restricted flow at the position of FIG. 8D ensures that the impeller of the flow metering device does not spin at high speed and thus does not gain high inertial forces and accordingly, when a flow pulse through the valve device 150 ceases, the impeller of the flow meter will immediately halt thus not incurring excessive metering.

In this position, the sealing sleeve 180 facilitates slow filling of water into the confined space 174, thus damping/slowing the closing stage of the valve, thereby improving the ratio between the measured consumption MC and the actual consumption AC.

It is however appreciated that the position of FIG. 8E is not a water consuming position but rather a position in which the piping downstream is refilled at a measurable pulse of water flow, to compensate for the water which has dripped from the piping and from the different supply devices.

With further reference to FIG. 8F, the valve 150 is illustrated in a completely opened position wherein water is consumed by a consumer downstream (not shown) resulting in complete displacement of the plunger 170 into engagement of the edges 170 with the corresponding edge 198 of the cup member 172, to give rise to an egg-like aerodynamic shape, facilitating water flow in a downstream direction at high flow rate, as per demand.

The addition of a damping assembly, i.e. the sealing sleeve 180 or any other damping means, e.g. a viscous fluid, friction arrangements, water orifice, etc. will result in measured consumption MC near to line IV in FIG. 6 whilst in the absence of such a damping assembly, the measured consumption is near to line III in FIG. 6.

At the absence of sealing sleeve 180, one would possibly sense a short delay in water supply upon consumption downstream, e.g. upon opening a tap, etc., owing to water first entering the confined space 174 and only then flowing through the outlet 156 downstream. However, applying the elastic sealing sleeve 180 ensures that upon rapid build up of differential pressure over the device (as a result of water consumption downstream), above a predetermined threshold, the sealing sleeve 180 will deform to disengage from the cylindrical portion 178 of the cup member 172, thus facilitating rapid draining of the confined space 174, whereby a consumer downstream does not feel a pressure drop.

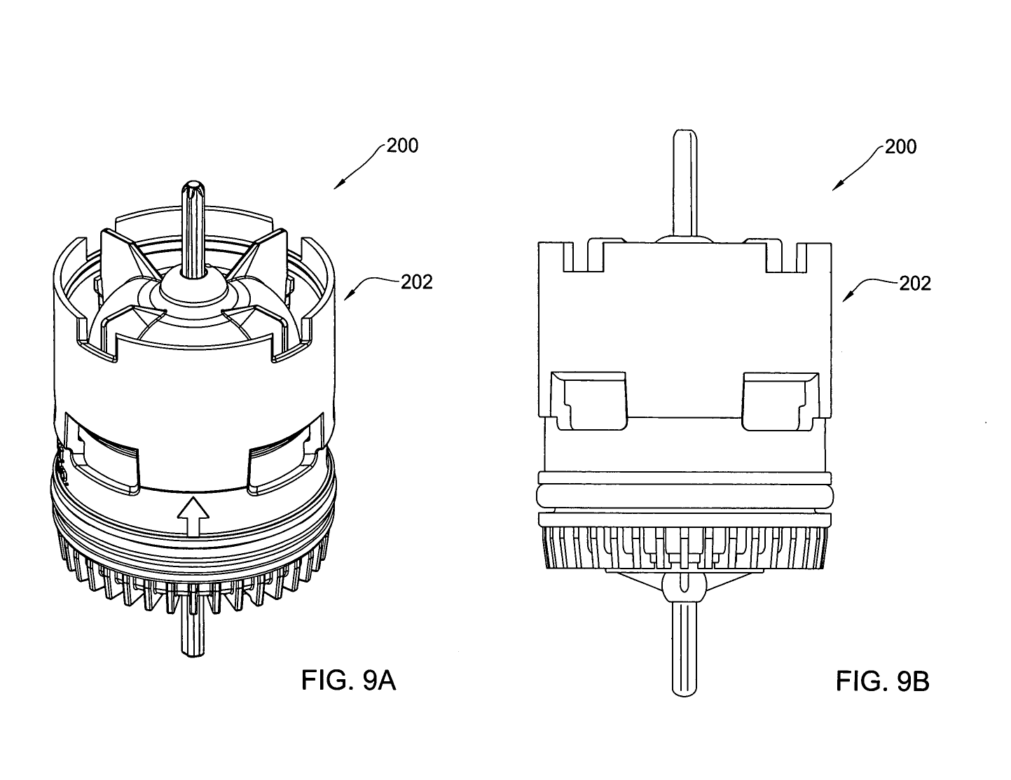

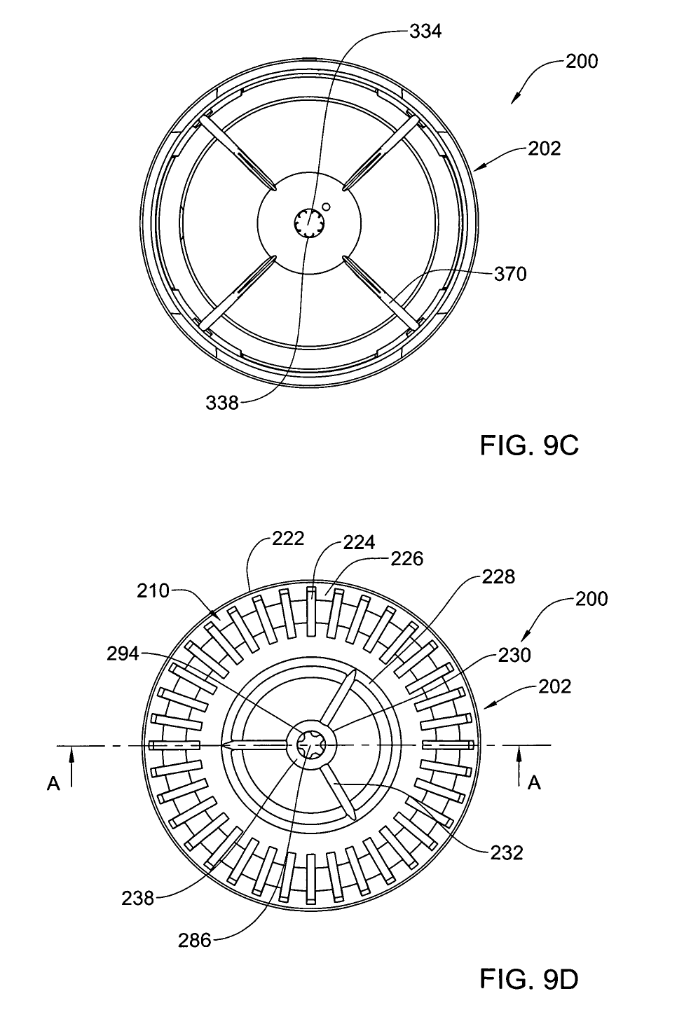

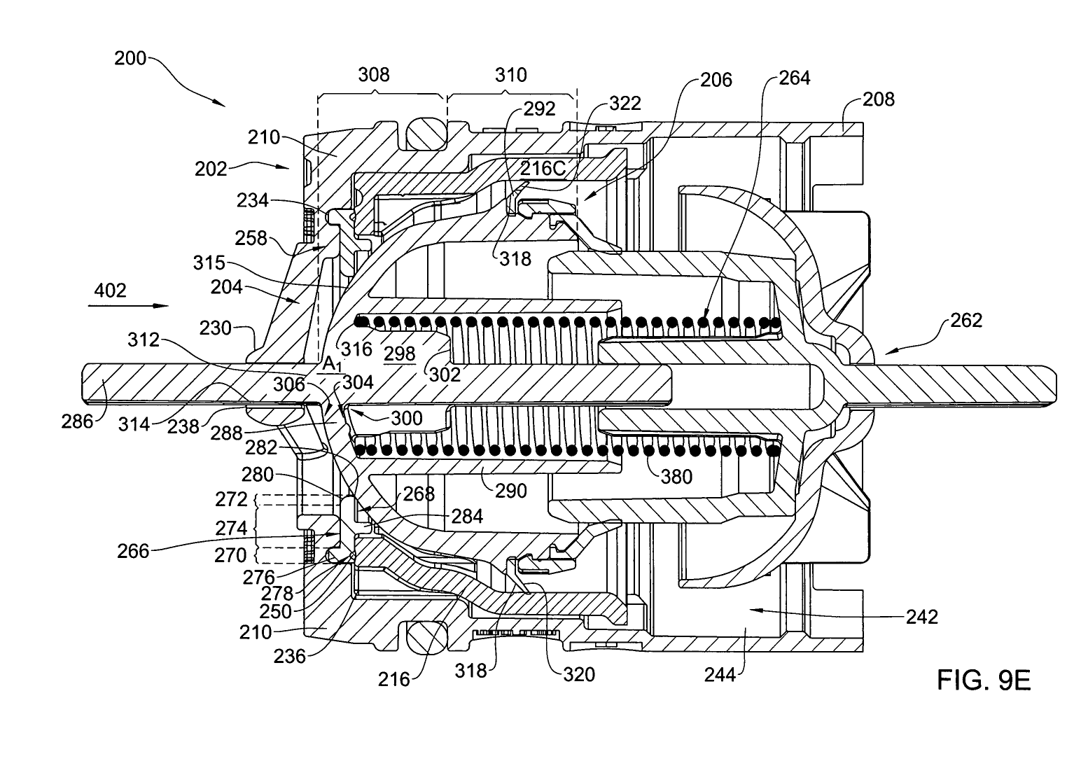

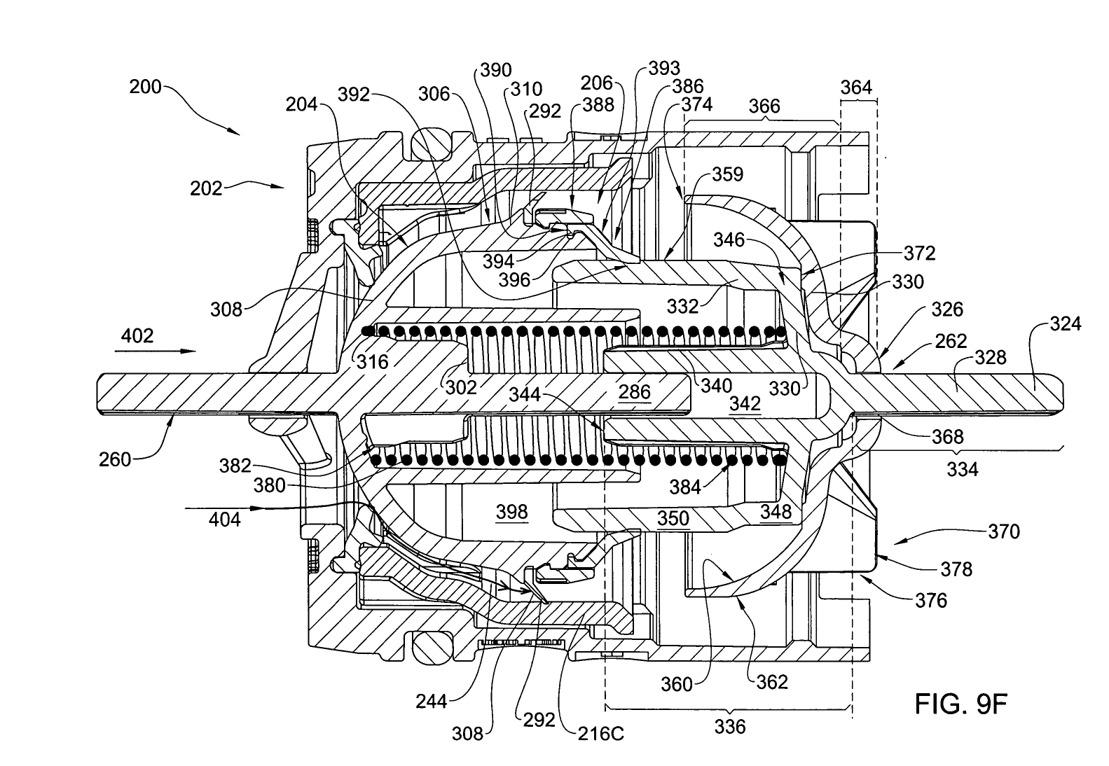

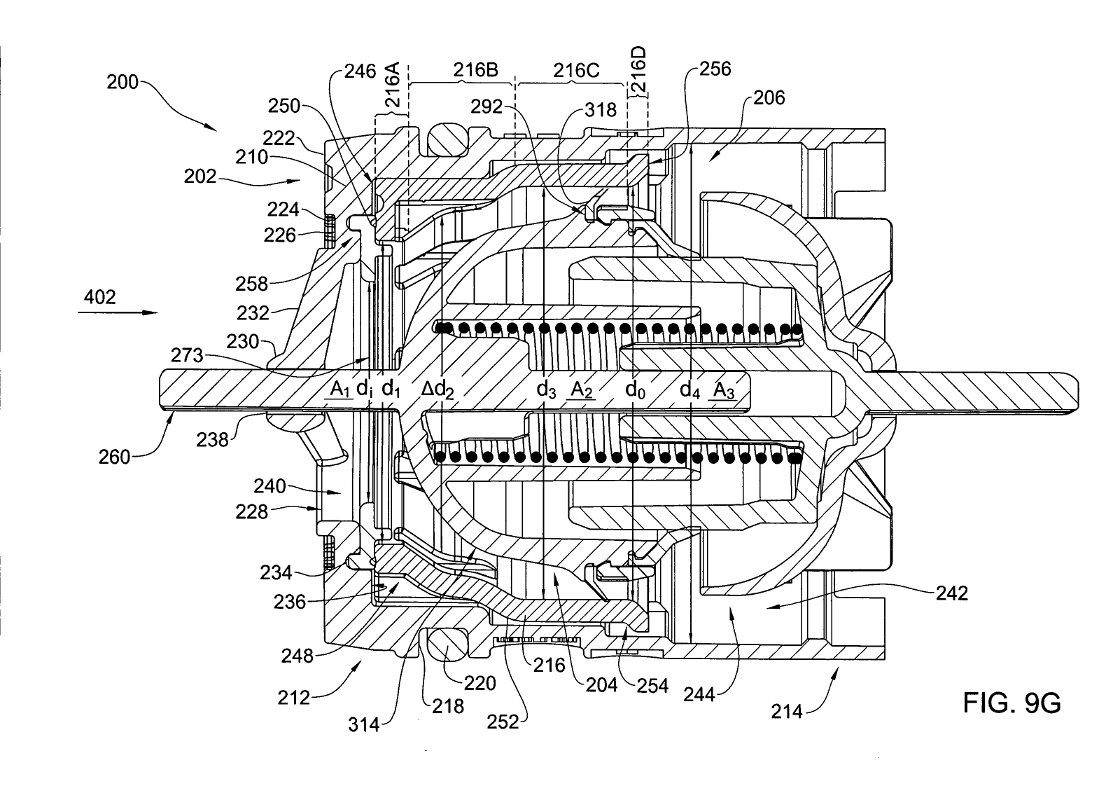

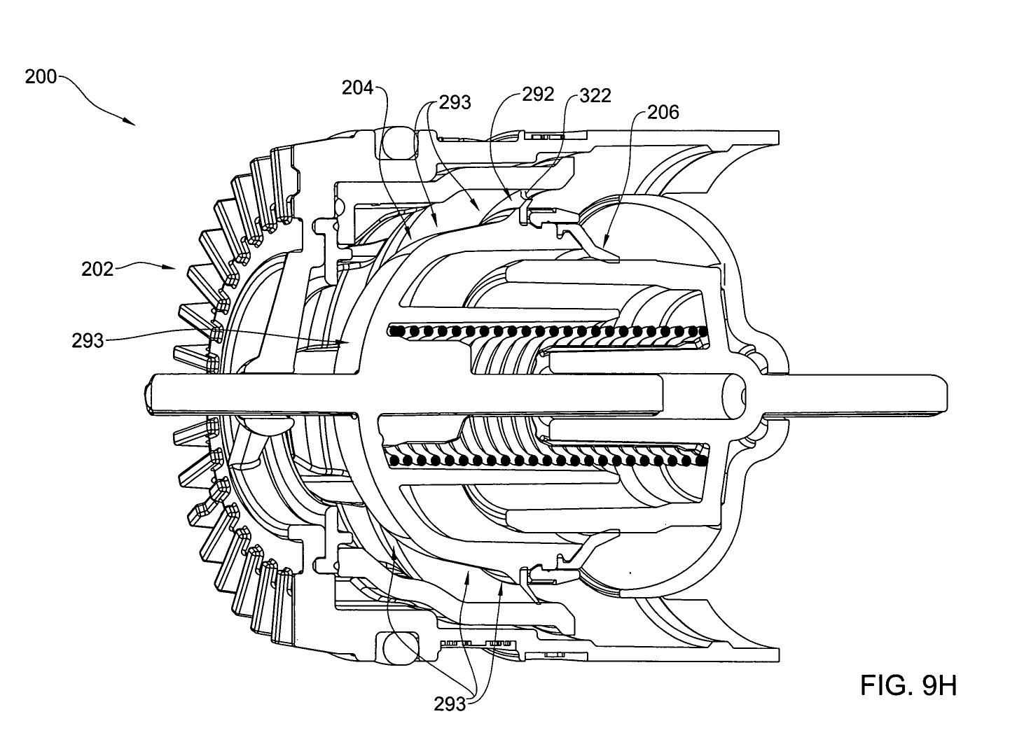

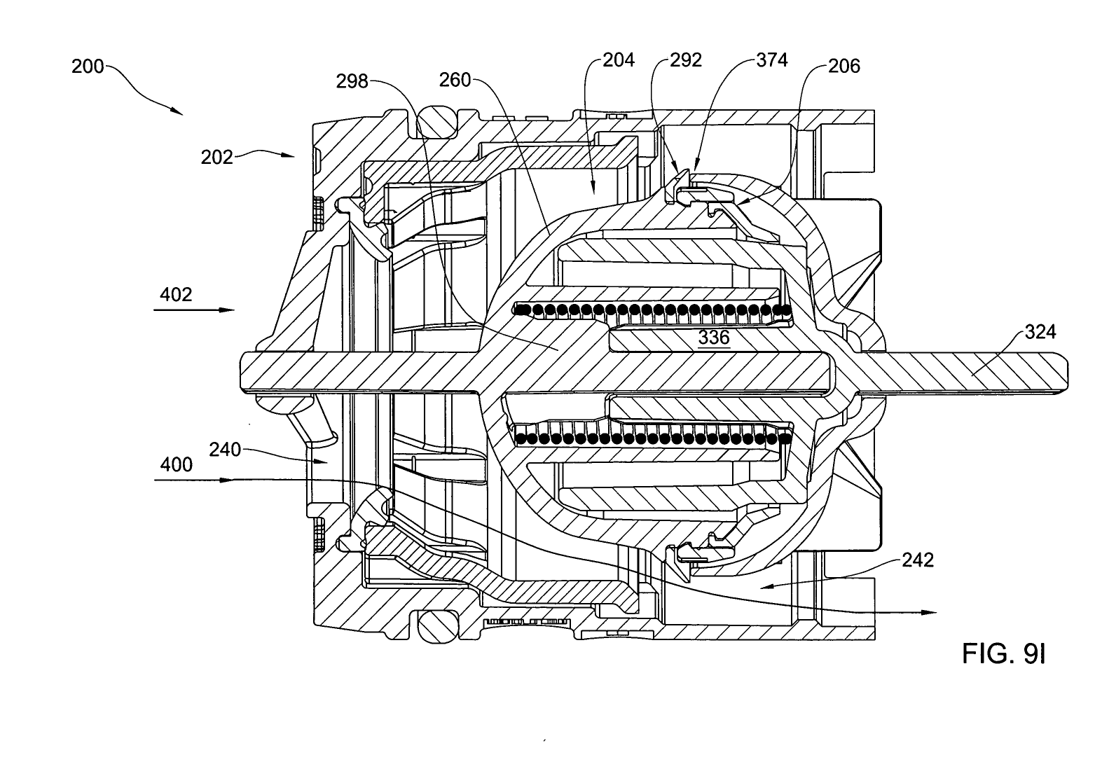

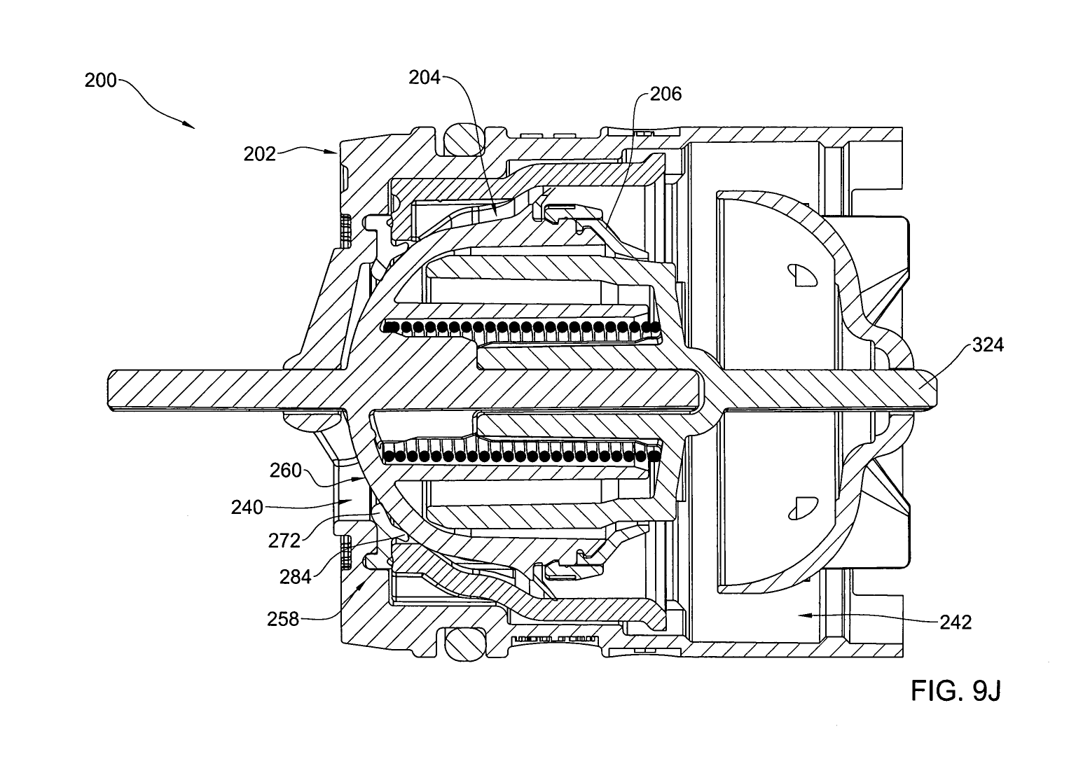

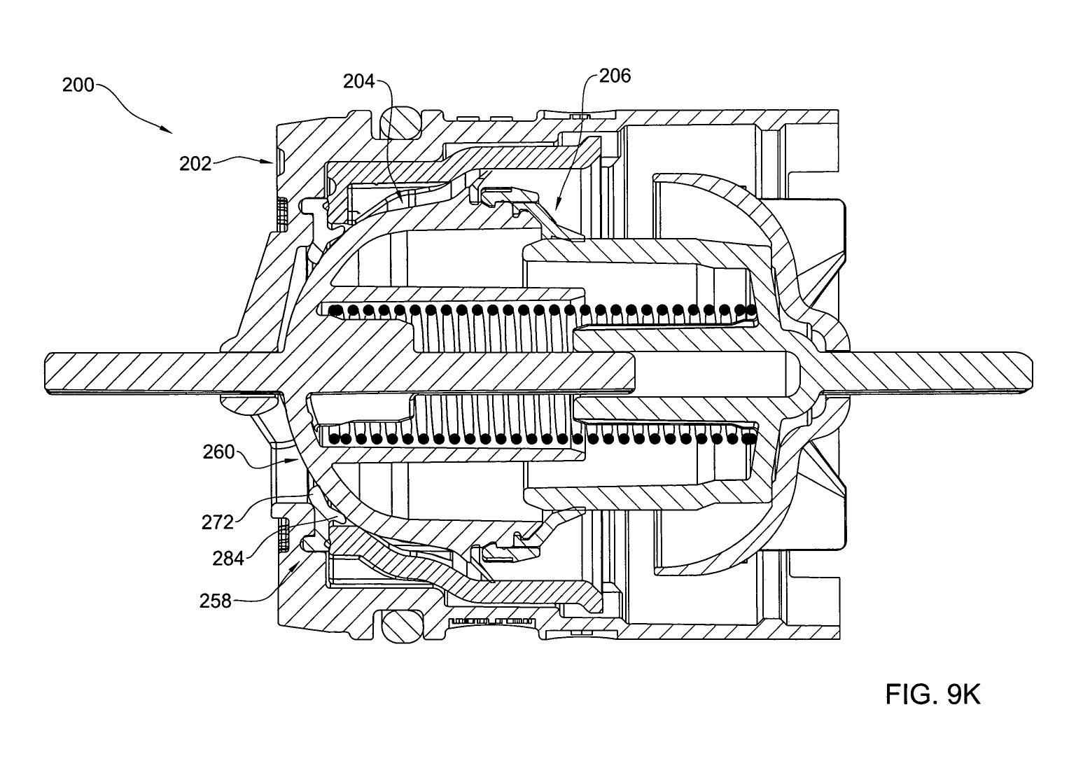

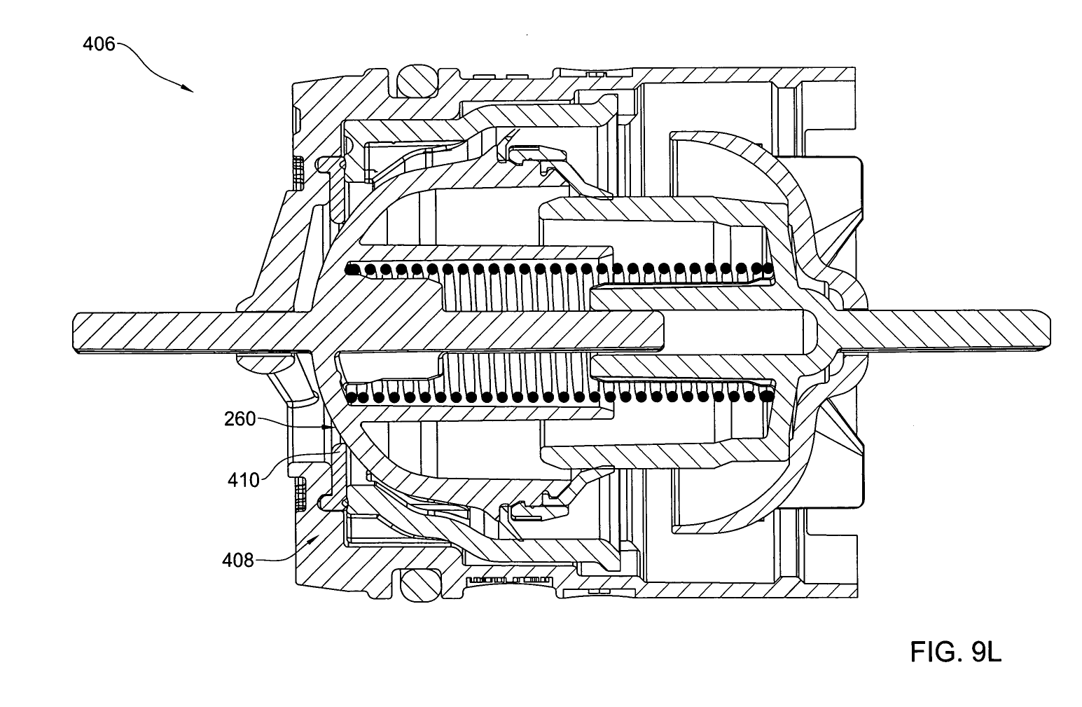

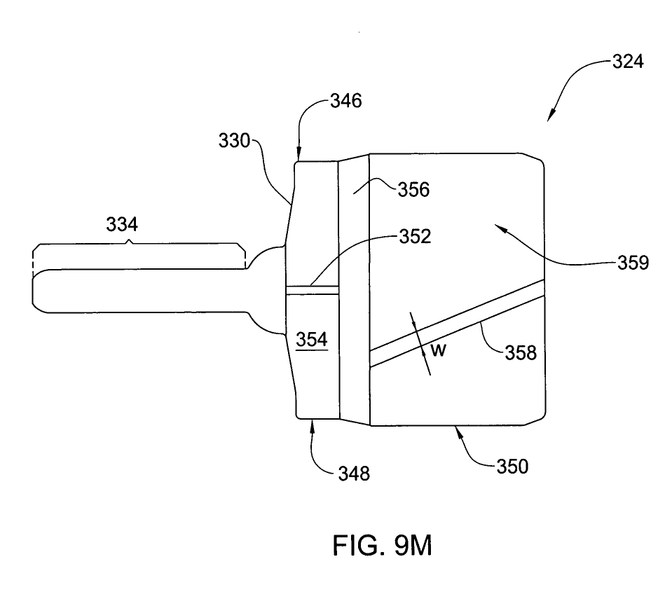

Referring now to FIGS. 9A-9K, there is illustrated a modification of a valve in accordance with the subject matter herein, generally designated 200. The valve 200 is configured to be used with a fluid supply system (not shown). Optionally, the fluid supply system in the present example may be the system shown in FIG. 1 and the valve 200 may be mounted in the fluid supply line 10 thereof.

The valve 200 comprises a housing, generally designated as 202, a pressure responsive sealing assembly, generally designated as 204, disposed within the housing 202, and a delay assembly, generally designated as 206, associated with the pressure responsive sealing assembly 204.

Referring now to FIG. 9G, it can be seen that the housing 202 comprises a cylindrical side wall 208, an annular end wall 210, and a diaphragm seal generally designated as 258.

The side wall 208 has inlet and outlet ends (212, 214), and comprises an inner cylinder 216 disposed therein, which will be further described hereinafter. The side wall 210 is formed with an external groove 218 at the inlet end 212, configured to receive an o-ring 220. The valve 200 further comprises an o-ring 220 configured be mounted in the external groove 218 and to allow fluid-tight engagement with a body (not shown) within which the valve 200 is mounted.

The annular end wall 210 extends inwardly from the inlet end 212 of the side wall 208. Drawing attention also to FIG. 9D, the annular wall 210 comprises an outer edge 222, a plurality of radially extending ribs 224 formed on an external surface 226 of the annular end wall 210 and disposed adjacent the outer edge 222 thereof, an inner annular edge 228, a guiding element 230, and three radially extending support members 232 connecting the guiding element 230 to the inner annular edge 228.

Referring now only to FIG. 9G, the annular end wall 210 is further formed with an annular groove 234 at an internal surface 236 thereof.

The guiding element 230 is formed with a central aperture 238.

The diaphragm seal 258 is formed with an annular shape and is mounted on an inlet port 240 of the housing 202, at an internal surface 236 of the annular end wall 210 thereof. The diaphragm seal 258 is made of an elastic and flexible material. The diaphragm is configured to allow the diaphragm seal 258 to flex and remain in contact with the sealing element when it begins to move, and to snap back to a normal position, upon sudden detachment from the sealing element when the sealing element moves further away from the diaphragm seal 258. The diaphragm seal 258 comprises first and second opposite sides (266, 268), outer and inner ends (270, 272) and a central portion 274 extending therebetween.

The outer end 270 of the diaphragm seal 258 comprises a mounting projection 276 which extends from the first side 266 in a direction away from the second side 268 of the diaphragm seal 258. The mounting projection 276, when the diaphragm seal 258 is mounted in the valve 200, is mounted within the annular groove 234 of the internal surface 236 of the annular wall 210. The diaphragm seal 258 is thus retained in its position by the inner cylinder 216 and annular end wall 210.

The inner end 272 of the diaphragm seal 258 is a projection configured for sealing engagement with the sealing member 260, as seen in the closed position shown in the present figure (FIG. 9E). The inner end 272, in this example, projects into an inlet port 240 of the housing 202, which thereby defines an orifice 273 therebetween. The inner end 272 is formed with first and second opposite corners (280, 282) disposed at the first and second sides (266, 268), respectively. The first corner 280 having a convexly-curved shape. The second corner 282 is a sharp-edged corner. In this example the sharp-edge forms a substantially right-angled shape. The first corner 280, when the diaphragm seal 258 is mounted in the valve 200, is disposed proximate the internal surface 236 of the annular wall, and the second corner 282 is disposed distal thereto.

The central portion 274 of the diaphragm seal 258 is formed with an additional engagement projection 284 which extends from the second side 268 in a direction away from the first side 266 of the diaphragm seal 258. When the diaphragm seal 258 is mounted in the valve 200, the additional engagement projection 284 extends in a direction away from the internal surface 236 of the annular wall 210. The direction of the additional engagement projection 284 is configured such that when engagement with the sealing member 260 occurs (seen in FIGS. 9J and 9K), the additional engagement projection bends in a direction away from the inner end 272 of the diaphragm seal 258.

The housing 202 further comprises an inlet port 240, an outlet port 242 and a control chamber, generally designated as 244, extending from the inlet port 240 to the outlet port 242 and including the internal areas thereof.

Notably, the control chamber 244 has an inner diameter di at the inlet port 240, and an inner diameter do at the outlet port 242. The inner diameter di is the diameter at the inlet port 240 which is configured to be sealed by the pressure responsive sealing assembly 204. In this example, the housing 202 comprises a diaphragm seal 258 having an inner end 272 projecting inwardly into the inlet port, therefore the inner diameter di is the diameter within the orifice 273 formed by the inner end 272 of the diaphragm seal 258.

The inlet port 240 is connectable to an upstream side of a fluid supply line (not shown).

The outlet port 242 is connectable to a downstream side of a fluid supply line (not shown).

It is further noted that the inner cylinder 216 comprises a first, second, third and fourth section (216A, 216B, 216C, 216D).

The first section 216A of the inner cylinder 216 has a substantially constant first inner diameter d1 and extends from a first end 246 of the inner cylinder 216 disposed adjacent to the internal surface 236 of the annular end wall 210 to a point of intersection 248 with the second section 216B. The first inner diameter dl is of a magnitude larger than the inner diameter dᵢ at the inlet port 240. The first section 216A is also formed with an annular projection 250 configured to bias the diaphragm seal 258 against the internal surface 236 of the annular wall 210.

The second section 216B of the inner cylinder 216 has a varying second inner diameter Δd2, which continuously increases in magnitude from the first inner diameter d1 at the point of intersection with the first section 248. The second section 216 B extends from the point of intersection 248 with the first section 216A to a point of intersection 252 with the third section 216C.

The third section 216C of the inner cylinder 216 has a substantially constant third inner diameter d3, which corresponds to the largest inner diameter of the second inner diameter Δd2 at the point of intersection 252 with the second section 216B. The third section 216C extends between the point of intersection 252 with the second section 216B and a point of intersection 254 with the fourth section 216D.

The fourth section 216D of the inner cylinder 216 has a varying fourth inner diameter Δd4, which continuously increases in magnitude from the inner diameter d3 at the point of intersection 254 with the third section 216C. The fourth section 216D and extends between the point of intersection 254 with the third section 216C and a second end 256 of the inner cylinder 216.

Notably, the diameter dₒ at the outlet port 242, adjacent to the second end 256 of the inner cylinder 216, is of a magnitude larger than the fourth inner diameter Δd4 of the fourth section 216D of the inner cylinder 216. Thus an area A3 of the control chamber 244 adjacent the second end 256 of the inner cylinder 216 constitutes an expanded portion of the control chamber 244.

Notably each inner diameter (d1, Δd2, d3, Δd4) of the inner cylinder 216 also constitute the diameter of the control chamber 244 at the same point. Additionally, since each cross-sectional area of the control chamber 244 is generally circular at each point along a longitudinal axis of the valve, comparative sizes of diameters of the control chamber 244 at longitudinal points corresponds with the comparative sizes of a cross-sectional areas at the same points.

Thus some dimensions of the control chamber 244 may be summarized as follows: A first cross-sectional area A1 of the control chamber 244 within the orifice 273 of the diaphragm seal 258 at the inlet port 240 is smaller than a second cross-sectional area A2 of the control chamber 244 within the third section 216C of the inner cylinder 216. The second cross-sectional area A2 of the control chamber 244 is smaller than a third cross-sectional area A3 of the control chamber 244 adjacent to the second end 256 of the inner cylinder 216.

Optionally, in the present example, the cross-sectional area A1 within the inlet port 240 is one quarter of the magnitude of the second cross-sectional area A2 within the third section of the inner cylinder. Optionally, in the present example, the cross-sectional area A3 is greater in magnitude than the magnitude of the first and second cross-sectional areas (A1, A2) combined.

It will be understood that while the present example comprises an inner cylinder 216 to provide different cross-sectional areas within the housing 202, an alternative construction may include a housing 202 with an integral design, which allows for different cross-sectional areas. An example of a housing with integrally formed different cross-sectional areas may be seen, for example, in FIG. 7.

Referring now to FIG. 9E, the pressure responsive sealing assembly 204 comprises a sealing member, generally designated as 260, disposed within the control chamber 244 and configured for sealing engagement with the diaphragm seal 258, a stopping assembly, generally designated as 262, configured to arrest motion of the sealing member 260, and a biasing mechanism 264 configured to normally bias the sealing member 260 into sealing engagement with the diaphragm seal 258.

The sealing member 260 is in the form of an axially displaceable plunger. The sealing member 260 comprises a shaft portion 286, a convex portion 288, a cylindrical extension 290 and an annular shoulder portion 292.

The shaft portion 286 is formed with five longitudinal ribs 294 evenly spaced about the periphery thereof, as best seen in FIG. 9D. One end of the shaft 286 is configured for sliding movement through the central aperture 238 of the guiding element 230. A central section 296 of the shaft portion 286 comprises enlarged ribs 298 which extending from a point of connection 300 of the shaft portion 286 with the convex portion 288. The enlarged ribs 298 are formed with a flat end 302 and are thus configured to be used as a mechanical stopper.

The convex portion 288 comprises internal and external surfaces (304, 306), a convexly curved base 308 and a substantially straight peripheral end 310 extending from the base 308.

The base 308 extends from a middle section 312 of the shaft portion 286 and the external surface thereof constitutes an inlet sealing surface 314. The inlet sealing surface 314 having a first sealing surface area sufficient in size, and configured for, sealing the cross-sectional area A1 within the diaphragm seal orifice 273. The base 308, at the internal surface 308 thereof, also comprises a spring seating portion 316.

The cylindrical extension 290 from the internal surface 304 of the base 308 in a direction parallel with the shaft portion 286.

The shoulder portion 292 is mounted on the external surface 306 of the peripheral end 310 of the convex portion 288 and comprises a first side 318 and a second side 320. The first side 318 being proximate to the base 308 of the convex portion 288 and the second side 320 being distal thereto. It can therefore be seen that the shoulder portion 292 is spaced from the inlet sealing surface 314. The shoulder portion 292 is in the form of an annular plunger seal. The shoulder portion 292 extends to and engages the third section 216C, when adjacent thereto as in the present figure (FIG. 9E). The shoulder portion 292 further comprises a sharp-edged circumferential peripheral edge diagonally inclined towards the side wall 208 of the housing 202 and the outlet port 242. The shoulder portion 292 also serves as a scraper bearing against the third section 216C, for continuously cleaning it from scale, algae and other dirt particles, as the sealing member 260 axially displaces therealong. The shoulder portion 292 further comprises a bleed aperture 322 (seen best in FIG. 9H). The bleed aperture 322 in this example is a curved slot formed in the shoulder portion 292. The bleed aperture 322 is configured to assist movement of the pressure responsive sealing assembly, upon fluid flow therethrough below a predetermined leak rate, as will be explained in further detail hereinafter.

Notably the third section 216C of the inner cylinder 216 of the housing 202 is elongated along the longitudinal direction. Also of note is that the shoulder portion 292, when the valve 200 is in closed position (FIG. 9E), is adjacent a portion of the third section 216C which is spaced from the expanded portion A3.

Referring now to FIG. 9F, the stopping assembly 262 comprises an axially displaceable piston 324 and a guide member 326 configured to guide the motion of the piston 324 in along an axial path.

The piston 324 comprises a shaft section 328, a spring seat section 330 extending from the shaft section 328, and a cylindrical sleeve section 332 extending from the spring seat section 330.

The shaft section 328 comprises a first part 334 and a second part 336.

The first part 334 is formed with five longitudinal ribs 338 evenly spaced about the periphery thereof, as best seen in FIG. 9C.

The second part 336 is formed with six longitudinal ribs 340 (best seen in FIG. 9H) evenly spaced about the periphery thereof, a recess 342 configured to slidingly receive the shaft portion 286 of the sealing member 260 therein, and a flat edge 344 configured for engagement with the flat edge 302 of the enlarged portion of the shaft portion 286 of the sealing member 260.

The spring seat section 330 extends outwardly from the second part 336 of the shaft section 328 in a radial direction and comprises a peripheral edge 346.

The cylindrical sleeve section 332 comprises a first annular portion 348 and a second annular portion 350.

Referring briefly to FIG. 9M, the first annular portion 348 extends outwardly from the peripheral edge 346 of the spring seat section 330 in a longitudinal direction and is formed with a longitudinal projection 352 along an external surface 354 thereof.

The second annular portion 350 has a larger diameter than the first annular portion 348. The second annular portion 350 extends outwardly from a peripheral edge 356 of the first annular portion 348 in a longitudinal direction. The second annular portion 350 is formed with a diagonal groove 358 along an external surface 359 thereof.

Reverting to FIG. 9F, the guide member 326 has inner and outer surfaces (360, 362), a first convexly curved part 364, and a second convexly curved part 366 extending from and larger than the first convexly curved part 364.

The first convexly curved part 364 is formed with an aperture 368 configured to slidingly receive the first part 334 of the shaft section 328.

The second convexly curved part 366 is formed with four evenly spaced radially extending guide vanes, generally designated as 370, extending from at the outer surface 362 thereof, a flat annular seating portion 372 disposed at the inner surface 360 thereof and configured to seat the spring seat section 330 of the piston thereon, and a peripheral edge 374 substantially corresponding in diameter to the shoulder portion of the sealing member 260 (best seen in FIG. 9I).

The guide vanes 370 each comprise a straight peripheral longitudinal edge 376 and a straight peripheral radial edge 378.

The peripheral longitudinal edges 376 are configured to substantially correspond in diameter to an internal longitudinal surface of a body (not shown) engaging the outlet port 242 of the valve 200. Engagement of the peripheral longitudinal edges 376 with the internal surface serves to reduce non-axial motion of the guide member 326 and hence the piston 324.

The peripheral radial edges 378 are configured to act as a mechanical stopper. The peripheral radial edges are configured to engage an internal radial surface of the body (not shown) engaging the outlet port 242 of the valve 200. The radial surface being configured to allow fluid flow therethrough. Engagement of the peripheral radial edges 378 with the internal radial surface serves to arrest axial motion of the guide member 326 at a desired point.

The biasing mechanism 380 comprises a spring having a predetermined biasing force Fₛ. The spring 380 is a compression spring comprising first and second ends (382, 384). The first end 382 is seated on the spring seating portion 316 of the sealing member 260. The second end 384 is seated on the spring seat section 330 of the piston 328. The sealing member 260 is normally biased by the spring 380 into a sealed position, so as to seal the inlet port 240 (as seen in FIG. 9E).

The delay assembly 206 is configured to slow the closing of the valve 200. The delay assembly 206 is configured to compensate for inertial effects that could cause an inaccurate flow measurement by an associated flow meter (not seen). The delay assembly 206 comprises a sealing element 386. Optionally, in this example, the delay assembly further comprises a locking member 388.

The sealing element 386 is in the form of a sleeve is made of a resilient material, which comprises first and second ends (390, 392) and a central portion 393 extending therebetween.

The first end 390 of the sealing element 386 comprises an annular projection 394. The first end 390 is securely mounted in a fluid tight manner to the external surface 306 of the peripheral end 310 of the sealing member 260. The annular projection 394 is fitted to a first annular recess 396 formed in the external surface of the peripheral end 310.

The second end 392 of the sealing element is of a smaller diameter than the first end 390. The second end 392 slidingly engages the external surface 359 of the second annular portion 350 of the piston 325.

Notably, the sealing element 386 sealingly connects the sealing member 260 and the stopping assembly 262, creating a confined space 398 therebetween.

The central portion 393 is configured to bend when subjected to bending forces.

The locking member 388 is of an annular shape and is mounted on both the external surface 359 of the piston 325 and the first end 390 of the sealing element 386. The locking member thus ensures that the sealing element remains securely mounted to the sealing member 260. Notably, the locking member 388 also serves to prevent movement of the annular shoulder 292.

Further attention is now directed to FIGS. 9E to 91, illustrating operation of the valve 200.

When there is a normal consumption of fluid downstream by a consumer, i.e. at a high flow rate (for example over 100 liters/hour), a sudden large pressure differential is caused about the inlet and outlet ports (240, 242) of the valve 200. The pressure differential producing a force (the direction of which is indicated schematically by an arrow designated as 402) on the first sealing surface area 315 (FIG. 9E) of the sealing member's 260 inlet sealing surface 314, which opposes and overcomes an opposing smaller force of the biasing mechanism 264, and the valve 200 moves rapidly from the closed position seen in FIG. 9E to an open position where the plunger seal is within the third cross-sectional area A3 of the control chamber 244 adjacent to the second end 256 of the inner cylinder 216. In the fully open position, as shown in FIG. 9I, the motion of the sealing member 260 is stopped by the engagement of the enlarged ribs 298 of the sealing member 260 and the second part 336 of the piston 324 halting the motion of the sealing member 260.

In the fully open position a fluid path 400 is created between the inlet and outlet ports (240, 242), allowing a high flow rate therethrough, as per demand.

When there is no consumption of fluid downstream by a consumer, i.e. consumption of fluid at a high flow rate, but there is a leak downstream, i.e. at a low flow rate, which, in this example, is a flow rate less than twenty five liters/hour, the operation of the valve 200 is as described below.

With reference to FIG. 9E, the valve 200 is illustrated in a closed position with the biasing mechanism 264 biasing the sealing member 260 into sealingly engagement with the diaphragm seal 258. In this position fluid (not shown) upstream of the inlet port 240 is prevented from reaching the outlet port 242 of the valve 200 by the pressure responsive sealing assembly 204.

Before leakage or consumption in the downstream supply line occurs, water pressure at the inlet port 240 is substantially equal to the pressure at the outlet port 242, i.e., the pressure differential ΔP equals 0 namely, the inlet pressure equals the outlet pressure (Pi=Po).

When leakage downstream of the valve 200 begins, i.e. at the low flow rate which below the measurable threshold of an associated fluid measuring device (not shown), this results in pressure decrease at the outlet port 242 of the valve 200, building up a pressure differential ΔP≧0 over the inlet and outlet ports (240, 242). The pressure built up at the first cross-sectional area A1 by the differential ΔP creates a force in direction 402 the first sealing surface area 315 (FIG. 9E) of the sealing member's 260 inlet sealing surface 314.

When the pressure differential over the inlet and outlet ports (240, 242) is still relatively small the force produced thereby on the inlet sealing surface 314 of the sealing member 260 is smaller than the opposing force of the biasing mechanism 264, and therefore the sealing member 260 does not move from the closed position illustrated in FIG. 9E.

As the pressure differential ΔP continues to be built up, due to continued leakage, the force opposing the biasing mechanism 264 grows.

Drawing attention now to FIG. 9F, when the pressure differential AP is built to a predetermined threshold value the sealing member 260 is caused to slightly extract in a downstream direction (402) towards the outlet port 242. Additionally, the inner end of the diaphragm seal 258 slightly bends in a direction towards the outlet port 242. Reduced engagement of the diaphragm seal 258 with the sealing member 260 allows fluid to penetrate into a fluid flow path 404 formed between the sealing member 260 and the control chamber 244 of the housing 202. The fluid flow in path 404 ends at the first side 318 of the shoulder portion 292, due to engagement of the shoulder portion 292 of the sealing member 260 with the third section 216C. It will be understood that a small amount of fluid can pass through the bleed aperture 322, however this amount is insufficient to affect the presently described operation of the valve 200.

The sealing member 260 then continues to more towards the outlet port 242 causing disengagement of the diaphragm seal 258 and sealing member 260, as shown in FIG. 9G Rapid disengagement of the diaphragm seal 258 and sealing member 260 causes the pressure differential to be suddenly about the second sealing surface area and the outlet port 242 causing the sealing member 260 to move more rapidly towards the outlet port 242.

Referring now to FIG. 9Q it will be understood that when the sealing member 260 is fully detached from the diaphragm seal 258 but the shoulder portion is still disposed within the third section of the inner cylinder, as illustrated, the pressure differential ΔP is no longer over the inlet and outlet ports (240, 242). Rather the pressure differential ΔP is now over a second sealing surface area 293 (FIG. 9H) and the outlet port 242. The second sealing surface area 293 being constituted by the first side 318 of the shoulder portion 292 together with the remainder of the surface area of the sealing member 260 upstream of the shoulder portion 292. Therefore the pressure differential ΔP now produces a force over the second sealing surface area 293 having a cross-sectional area equal to the third cross-sectional area d3 (FIG. 9G) within the third section 216C of the inner cylinder 216. Since the area upon which the pressure differential ΔP acts, i.e. on the second sealing surface area 293 is now suddenly far larger (in this example the second sealing surface area 293 is about four times larger than the first sealing surface area 315 (FIG. 9E)), than was the case in the closed position (FIG. 9E), the force produced on the sealing member 260 in a direction 402 towards the outlet port 242 is also suddenly far larger (i.e. about four times larger). This suddenly increased force on the sealing member 260 rapidly overcomes the opposing force of the biasing mechanism 264 and the sealing member 260 rapidly moves towards the open position of the valve 200 shown in FIG. 9I.

The rapid opening of the valve 200 under the built up pressure differential causes a measurable flow rate of fluid to pass through the valve 200 and hence move through the supply line (not shown).

With reference to FIG. 9F, when the sealing member 260 moves towards the stopping assembly 262 as described above, increased pressure within the confined space 398 causes the central portion 393 to bend causing the second end 392 of the sealing element to be slightly spaced from the external surface 359 of the second annular portion 350 of the piston 324, i.e. causing a gap (not shown) therebetween. The gap allows fluid in the confined space 398 to rapidly exit therethrough. Therefore the delay assembly 206 does not significantly delay opening of the valve 200.

Notably, the central portion 393 is elongated sufficiently to engage the external surface 359 of the second annular portion 350 of the piston 324 at a point thereof spaced from the sealing member 260. Thus if the central portion 393 is bent inwardly, i.e. in the direction of the base 308 by forces external to the confined space 398, the second end 392 of the sealing element 386 will not detach from the piston allowing fluid flow into the confined space 398.

Since the opening of the valve 200 was only caused by a leak downstream of the supply line, the pressure differential about the valve 200 is quickly reduced and the valve 200 begins to close.

The sealing element 386 of the delay assembly 206 facilitates slow closing of the valve 200, by regulating fluid entry into the confined space 398. Fluid entry into the confined space 398 is aided by the passage of fluid (not shown) through the diagonal groove 358 (FIG. 9M). The elongated length of the third section 216C of the inner cylinder of the housing 202 is configured to allow an extended period of time for sufficient fluid to pass through the diagonal groove 358.

The diagonal orientation of the configuration is configured to allow an increased circumferential length of the sealing element to engage with the groove as the piston displaces axially, thereby preventing partial closing of the groove by the sealing element due to local relaxation of the sealing element.

It will be understood that the slowing of the closing of the valve 200 improving the ratio between the measured consumption MC and the actual consumption AC in flow measuring devices that suffer from inertia after the cessation of fluid flow.

The delay assembly 206 is therefore configured to slow the valve 200 from moving quickly into the closed position

To prevent the sealing member 260 from reaching a steady state position when moving from the fully open position towards the closed position, the bleed aperture 322 reduces the force opposing the biasing force of the biasing mechanism 264, when fluid flow passes therethrough below a predetermined leak rate threshold from the inlet port to the outlet.

The valve 200 also serves also as a one way valve 200 preventing flow from a downstream direction to an upstream direction (in a direction opposite to the direction indicated by arrow 402), i.e. from the consumer towards the supplier.

It will also be noted that if the valve 200 is in the open position, as seen in FIG. 9I, and there is a sudden backflow (in an upstream direction, i.e. from the outlet port to the inlet port), the sealing member 260 and piston 324 are pushed to the inlet port 240 which becomes sealed by connection with the sealing member 260 (FIG. 9J). Notably, the piston slides together with the sealing member 260 because the delay assembly 206 does not allow fast release therebetween.

If, however, the valve 200 is in the closed position, as seen in FIG. 9E, and there is a sudden backflow (in an upstream direction), only the sealing member 260 is pushed into further engagement with the diaphragm seal 258 (FIG. 9K).

With further reference to FIGS. 9J and 9K, since the diaphragm seal 258 is formed with an inner end 272 and an additional engagement projection 284, both of which engage the sealing member 260 by bending in a direction away from each other during a sudden backflow (in an upstream direction), a hydraulic seal is formed between the sealing member 260 and the diaphragm seal 258.

While the diaphragm seal 258 of the valve 200 shown in FIGS. 9A-9K, provides a hydraulic seal during backflow, it will be understood that a valve 406 (shown in FIG. 9L), identical to valve 200 with the exception of diaphragm seal 408 will still perform in the same manner as described above in situations other than backflow. Notably, the diaphragm seal 408 is identical to the diaphragm seal 258, (and it therefore comprises an inner end 410) with the exception that it does not comprise an additional engagement projection configured to engage the sealing member 260.

It is appreciated that the above embodiments are merely example of valves suitable for use with a metering system and method as disclosed above, and many other such valves can be designed, all of which fall within the scope of the subject matter herein.

1. A valve comprising a housing and a pressure responsive sealing assembly; the housing comprises an inlet port, an outlet port and a control chamber extending therebetween; the control chamber having a first cross-sectional area at the inlet port, and a second cross-sectional area greater in magnitude than the first cross-sectional area and being disposed between the inlet port and the outlet port; the pressure responsive sealing assembly being normally biased into a first position in which the sealing assembly seals the inlet port; when a pressure differential about the inlet and outlet ports exceeds a predetermined threshold, the pressure responsive sealing assembly being configured to shift from the first position to a second position, in which the sealing assembly no longer seals the inlet port and a fluid flow path from the inlet port into the control chamber is opened, the fluid flow path being substantially obstructed in the second position at the second cross-sectional area of the chamber due to engagement thereat by the sealing assembly with the housing; the pressure responsive sealing assembly being configured to shift from the second position to a third position, in which the pressure responsive sealing assembly is disengaged from the housing at the second cross-sectional area allowing fluid to flow from the inlet port to the outlet port; the valve being formed with a bleed aperture configured to admit fluid flow therethrough in a direction from the inlet port to the outlet port.

2. The valve of claim 1, wherein the second cross-sectional area is at least four times the magnitude of the first cross-sectional area.

3. The valve of claim 1, wherein the control chamber has a third cross-sectional area greater in magnitude than the magnitude of the first and second cross-sectional areas combined and being disposed between the second cross-sectional area and the outlet port.

4. The valve of claim 1, wherein sealing assembly comprises an axially displaceable sealing member having an inlet sealing surface and an annular shoulder portion spaced from the inlet sealing surface; the inlet sealing surface being configured to seal the inlet port, when the pressure responsive sealing assembly is in the first position; the annular shoulder portion being configured to extend to and engage the housing at the second cross-sectional area of the control chamber, when the pressure responsive sealing assembly is in the second position.

5. The valve of claim 4, wherein the annular shoulder portion is formed with the bleed aperture.

6. The valve of claim 4, wherein the annular shoulder portion is configured for cleaning the housing.

7. The valve of claim 1, wherein the pressure responsive sealing assembly comprises a sealing member and a stopping assembly configured to arrest motion thereof; the stopping assembly comprising a piston configured to be axially displaceable.

8. The valve of claim 1, wherein the pressure responsive sealing assembly comprises a sealing member and a stopping assembly configured to arrest motion thereof; the sealing member and stopping assembly both being formed with convexly curved complimentary mating shapes configured to form an egg-like shape when brought together.

9. The valve of claim 1, wherein housing comprises a diaphragm seal mounted on the inlet port and comprising an inner end configured for sealing engagement with the pressure responsive sealing assembly in the first position, the first cross-sectional area being an area within the inner end of the diaphragm seal.

10. The valve of claim 9, wherein the diaphragm seal comprises outer and inner ends; the outer end being configured for mounting the diaphragm seal to the inlet port; the inner end being configured to project inwardly and being formed with a sharp-edged corner.

11. The valve of claim 10, wherein the sharp-edged corner is formed with a substantially right-angled shape.

12. The valve of claim 9, wherein the diaphragm seal comprises an outer end, an inner end and a central portion extending therebetween; the outer end being configured for mounting the diaphragm seal to the inlet port; the inner end being a projection configured for sealing engagement with a sealing member of the sealing assembly; the central portion comprising an additional projection configured to extend in a direction away from the central portion thereby allowing engagement with a sealing member of the sealing assembly to cause the additional projection to bend in a direction away from the inner end of the diaphragm seal.

13. The valve of claim 1, wherein the pressure responsive sealing assembly further comprises a biasing mechanism comprising a spring and configured to normally bias the sealing member into sealing engagement with the inlet port.

14. The valve of claim 1, wherein the valve is a one way valve, preventing fluid flow through the inlet port in a direction away from the outlet port.

15. The valve of claim 1, further comprising a delay assembly configured to engage the pressure responsive sealing assembly and slow movement thereof from the second or third position to the first position.

16. A valve comprising a housing, a pressure responsive sealing assembly and a delay assembly; the housing comprises an inlet port an outlet port and a control chamber extending therebetween; the pressure responsive sealing assembly comprising a displaceable sealing member configured to be displaced from a closed position, in which the sealing member seals the inlet port, to an open position in which the sealing member is disengaged from the inlet port to admit fluid flow through a fluid flow path between the inlet and outlet ports; the delay assembly being configured to engage the sealing member and slow movement thereof from the open position to the closed position.

17. The valve of claim 16, wherein the delay assembly comprises a sealing element configured to extend between the sealing member and another part of the valve, thereby creating a confined space between the sealing member and the part of the valve; the sealing member being configured to allow a first fluid flow rate for fluid exiting the confined space and a second fluid flow rate for fluid entering the confined space; the first fluid flow rate being greater than the second fluid flow rate.

18. The valve of claim 17, wherein the part of the valve is a part of a stopping assembly configured to arrest motion of the sealing member.

19. The valve of claim 18, wherein the sealing element is a sleeve comprising first and second ends and a central portion extending therebetween; the first end being securely mounted on the sealing member; the second end engaging the part of the stopping assembly; the central portion being configured to bend and being elongated sufficiently to engage the part of the stopping assembly at a point thereof spaced from the sealing member.

20. The valve of claim 19, wherein the part of the stopping assembly engaged by the sealing element is formed with a groove along an external surface thereof, configured to allow fluid flow into the confined space at the second fluid flow rate.

21. The valve of claim 20, wherein the groove is diagonal with respect to a longitudinal axis of the valve.

22. The valve of claim 21, wherein the valve being formed with a bleed aperture configured to admit fluid flow therethrough in a direction from the inlet port to the outlet port.

23. The valve of claim 16, wherein the pressure responsive sealing assembly further comprises a stopping assembly configured to arrest motion of the sealing member; the stopping assembly comprising a piston configured to be axially displaceable.
